(19) United States
(12) Patent Application Publication
(10) Pub. No.: US 2004/0058603 A1
(43) Pub. Date: Mar. 25, 2004

(54) Laminated tarp material

(76) Inventor: James F. Hayes, Rutherfordton, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/251,761

(22) Filed: Sep. 23, 2002

(51) Int. Cl. B32B 27/12; B32B 1/00; B32B 27/36; B32B 27/30

(52) U.S. Cl. 442/286; 442/287; 442/288; 442/291; 156/166; 156/307.1

(57) ABSTRACT

The present invention relates generally to a laminated tarp and a method of making this laminate. More particularly, the present invention relates to a laminated tarp containing multiple layers, including a fabric layer sandwiched between two layers of polymeric material comprising a vinyl (co)polymer and a polyurethane material. This laminated tarp can also include a thermosetting adhesive layer between the polyurethane material and the fabric layer, as well as a heat-sealable or weldable coating over the polyurethane material and/or over the vinyl (co)polymer layer. Also described is a method for making the laminated tarp.

### FIELD OF THE INVENTION

The present invention relates generally to a laminated tarp and a method of making this laminate. More particularly, the present invention relates to a laminated tarp containing multiple layers, including a fabric layer sandwiched between two layers of polymeric material comprising a vinyl (co)polymer and a polyurethane material that has sufficient strength, tear resistance, and weathering resistance to be used as a truck tarp, while having a very light weight, as compared to conventional truck tarps. This laminated tarp can also include a thermosetting adhesive layer between the polyurethane material and the fabric layer, as well as a heat-sealable or weldable coating over the polyurethane material and/or over the vinyl (co)polymer layer. Also described is a method for making the laminated tarp.

### BACKGROUND OF THE INVENTION

Tarpaulins (tarps) are used in many industries to covers and protected materials from sun, wind and rain. As such, tear strength, flexibility, and UV light resistance to keep tarps from degrading in the sun are important properties. Additional properties, such as antistatic, insulative, and fire retardant properties and leak-sealant abilities may be useful in some applications. Some tarps must be particularly strong or have increased tear resistance, which can be obtained by including reinforced cords or webbing. Some tarps must be perforated to allow water to pass through. Tarps can be available in a variety of colors, but are often a black/white reversible material to control heat build up.

The eventual use of the tarp in some ways dictates the construction. Potential uses and advantageous properties include:

Truck Covers—high strength, tear resistance, water resistance, outdoor UV resistance;

Wind Break Curtains—high strength, high wind permeability, outdoor UV resistance, cold resistance;

Construction Tarps—high strength, tear resistant;

Fire Salvage Covers—water resistance, outdoor UV resistance, cold resistance;

Storage Tarps—long term UV and cold resistance;

Pit and Pond Liners—water and chemical resistance, wet heat resistance;

Welding Curtains—tear resistance, fire resistance; or

Agricultural Tarps—water and air permeability, long term UV resistance.

Tarps are typically made from a fabric and a elastomer, where the elastomer is impregnated into and about the fabric. Typical examples are un-reinforced or reinforced polyester coated with vinyl, which is often available in 13 oz to 28 oz. weights; vinyl coated nylon, available in 14 oz. to 30 oz. weights. Typical athletic field tarpaulins are heavy-duty, i.e., thick, coatings of polyethylene or vinyl over reinforced polyester/nylon fabric. Weights between 20 oz./sq.yd. and 30 oz./sq.yd. are typical for conventional truck tarps.

Sandwiching a urethane adhesive layer between two fabric layers is known. See, for example, U.S. Pat. No. 3,684,639 to Keberle et al. which discloses the use of certain polyurethanes adhesives for heat sealing layers of textile sheets.

Use of layers of fabrics to increase the stiffness of the laminate is also known in the art. U.S. Pat. No. 5,424,114 to Groshen, relates to producing textiles for stiffening the fronts of clothing, shirts and blouse collars, and discloses a textile having outer textile layers bonded by a hot-sprayed polymer. The hot-sprayed polymer is crosslinkable and includes in particular, polyurethanes, polyamides or polyesters. Groshen states that it is necessary to crosslink the hot sprayed polymer in order for the final textile to withstand the usual washing, drying cleaning, and ironing that clothes are typically subjected to.

U.S. Pat. No. 4,942,082 to Murphy discloses a stiff alloy material of ionic and nonionic thermoplastic resins. Stiff laminates are constructed by extruding the alloy into a sheet or film and laminating a layer of fabric by conventional methods. See also U.S. Pat. No. 4,350,732 to Goodwin for a conventional method of attaching the polymeric resin layer to fabric by forming a preliminary sandwich laminate. The fabric may typically comprise non-woven or woven fabrics e.g. cotton, rayon, nylon, polyester, polypropylene, or blends thereof, and are impregnated with liquid saturation of a thermoplastic stiffening agent, an adhesive material or both. The alloys can be used to construct films or sheets which are used by themselves. Alternatively, the films or sheets thus formed of ionic and nonionic thermoplastic resin may be combined with fabric layers to make laminates for use as support stiffeners in clothing items.

Flexible, waterproof fabrics are also known in the art. U.S. Pat. No. 5,234,525 to Krishnan discloses coated fabrics or fabric laminates that are waterproof but are permeable to water vapor. Krishnan discloses the preparation of a fabric laminate comprising a waterproof basecoat sandwiched between two fabric layers. The coating is applied with doctor blade stations, the blades being set 2 or 3 mils above the cloth surface. The basecoat material is delivered to each doctor blade station at a metered rate to provide a particular coating weight and thickness. Following each doctor blade station is a solvent flashing and vapor recovery station. As a subsequent step, the coated cloth must pass through a curing oven. These coated fabric or coated fabric laminates are used in tents, rainwear and other garmets where both waterproofness and breathability are necessary.

U.S. Pat. No. 5,766,400 to Gallagher, the disclosure of which is incorporated by reference, discloses a method of manufacturing substrate fabric material in parallel with a synthetic film membrane to form a two ply laminate, and with outer substrate fabric material(s) to form multi-ply laminates. A thermoplastic film is placed between layers of fabric to enhance bonding, wherein the other side of the fabric has a film membrane laminated thereto. The laminate(s) and/or separate sheets of above materials are assembled by using a radio frequency welding. The invention teaches a method for making a sealed seam between two substrate fabric materials by using a thermoplastic polyurethane or polyolefin membrane placed between the two substrate fabrics. The method eliminates the necessity of post construction sewing or gluing the seams by substituting welding of seams.

U.S. Pat. No. 5,529,830 to Dutta et al. discloses a waterproof, stretchable fabric laminate formed from a composite layer bonded to at least one layer of an elastic fabric.

Layered articles or products which are water-proof, moisture permeable, and flexible are well known in the art. See, e.g., U.S. Pat. Nos. 4,493,870 to Vrouenraets et al., 4,443,511 to Worden et al., and 4,194,041 to Gore et al., all of which are hereby incorporated by reference. These products, which may be used to make fabrics to protect humans from wet weather, are formed of a hydrophilic layer covered with a hydrophobic layer. The hydrophilic layer may be a textile material layer as in U.S. Pat. No. 4,493,870 or films of polyurethane polymer/perfluorosulfonic acid product as in U.S. Pat. No. 4,194,041

U.S. Pat. No. 4,847,142 Twilley, et al. describes a laminated product formed from a block copolyether amide having a number average molecular weight of from about 15,000 to about 35,000 that contains polymer segments which are prepared by the amination of a polyether formed by treating a polyethylene glycol with an alkylene oxide having at least three carbon atoms, preferably propylene oxide.

As mentioned, prior art tarps are usually constructed of a fabric sandwiched between two vinyl layers. A woven fabric provides high tear strength and resistance to abrasion and punctures. The fabric is typically selected from woven polymer yams, such as nylon or a polyester, for example a polyethylene or polypropylene. A polyester yam is resistant to UV light and provides high tear strength after substantial outdoor exposure. Woven polymer material has good tear strength and light weight. Some special tarps have a single construction, such as woven or unwoven uncoated polypropylene at 4 oz. to 8 oz. weight, but these plastic sheets do not have the feel, tear resistance, and handling characteristics of fabric-based tarps.

Examples of commercially available tarps include tarps made of 2 layers vulcanized together with a fiber net in between which makes a tough tear resistant tarp at a low price. The fabric may be a 10 by 10 cross weave, i.e., 10 strands vertical and 10 strands horizontal per square inch. One commercial example, an 11 oz. vinyl laminated edge-reinforced nylon tarp, is watertight, has electronically welded seams and exhibits 100 lb. Tensile Strength and flame and cold weather resistant to about −20 degrees F. Such a light weight tarp, however, is not recommended by the manufacturer for use as a truck tarp, as it does not have adequate strength and tear resistance. Commercial blankets often include UV stabilizers in the lamination to provide for longer life of the tarp.

Canvas, particularly pre-shrunk canvas, can be used for a tarps. Cotton has good anti-abrasive qualities and breathability.

Ceramics or flame-resistant polymers can be incorporated to form a fire proof or fire resistant tarp.

Advantageously, tarps are rugged, flexible, and water and mildew resistant. Vinyl is used for most products, and it can meet the flame resistance requirements. It is also reasonably weather resistant. Vinyl has a cold crack temperature of −67 degrees. Polyethylene has also been used extensively in tarps.

In older manufacturing processes, tarps portions were joined together with sewn thread. Advantageously, heat welding is now used to join portions of tarp and provides adequate adhesion without threads. Alternatively, RF welding, or dielectric welding, is used to fuse materials together.

Newer tarps made from multilayered, reinforced material that has been coated with UV light inhibitors include:

a 12-20 mil woven reinforced 4-ply polyethylene, which may be treated to be fire retardant;

a 5-ply nylon string reinforced extrusion laminated polyethylene with 3 layers of blown LDPE film & 2 layers of rip-stop nylon tire cord;

a 6-20 mil woven reinforced 4-ply polyethylene, which may be treated to be fire retardant;

a polyester string reinforced 3-ply polyethylene; or

a 18-20 mil woven reinforced polyethylene, which may be treated to be fire retardant.

Another commercially available waterproof nylon tarp is made from 1.1 oz ripstop nylon tarps with silicone coating, with sizes from 9 oz to 18.8 oz per yard.

Tarps can include grommets, D-rings, and/or loop fasteners. Reinforcement, for example a web or a rope in the hem of a tarp, is often added to prevent grommet pullout.

A critical factor in tarp manufacture is cost. Tarps are viewed as disposable, and are purchased in significant volumes by users. Therefore, there is an industry-wide price pressure which makes cost of materials and cost of manufacture critical to the viability of tarp. The second critical factor in tarps is weight. Often, particularly with heavy duty industrial tarps such as truck tarps, a tarp may have a normalized weight of 18 to 22 ounces per square yard, or an overall weight of at least 150 pounds. Such a heavy article is difficult for one or even two people to lift onto the truck and to spread evenly prior to tie-down. As a result many truckers use automated tarp deployers, but these are prone to breaking, are expensive, and take up valuable space.

One way to reduce both cost and weight is to simply reduce the weight of the scrim and of the applied laminates—that is, to reduce the quantity of applied elastomer to lower levels. Thin coatings of laminates results in increased failure rates due to wear and tear. Commercially available lightweight tarps, such as 11 oz of vinyl-coated nylon, are available but are not recommended for use on trucks and other heavy duty applications. In some applications, a multiweight tap can be used, for example a commercially available hay tarp has 18 oz of vinyl-coated nylon on top, but the side drops only have 10 oz. of vinyl-coated nylon.

Tarps made from laminated fabrics are known, for example “ISOPLAN (TM)” Heavy Duty Trucking Fabric commercially from Hoechst Celanese Corporation, Charlotte, N.C. ISOPLAN (TM) fabric is a polyvinyl chloride (PVC) resin coated woven polyester fabric. Alternatively, the waterproof coating may be a polyurethane resin or PVC resin sheet material.

A failed tarp, due to elastomer degradation from exposure, or due to ripping, or due to delamination, can result in very high ancillary costs as material the tarp is intended to protect becomes exposed to damaging environment. A failed truck tarp can cause severe hazards on a highway. Therefore, adequate tear and weather resistance are essential.

There is a need for lightweight laminate tarps useful as truck tarps. There is also a need for a flexible laminate tarp having two outer surface polymeric layers, appropriate bonding material, and a middle inner layer of fabric. There is a need for a multi-layered laminate which can be manufactured quickly, in large quantities, and with uniform thickness. There is further a need for these multi-layered laminate to be heat and/or RF weldable with itself, to eliminate the need for sewn seams. There is a need for such lightweight laminates that are competitive with traditional heavy vinyl-coated tarps in the areas of strength, tear-resistance, and cost. There is a need in the art for a method of manufacturing these large, flexible laminate sheets, whereby the laminate sheets are manufactured in large quantities, quickly, and with precise control of a range of laminate thickness. The described invention solves these needs.

It is an object of the present invention to provide a laminate which is comprised of at least two outer polymer layers and an inner fabric layer, the laminate having a thickness which is substantially even throughout, and laving an inner polymeric adhesive layer.

It is a further object of the invention to provide a laminate which is light, tear-resistant, wear-resistant, waterproof, weather resistant, flexible, and relatively non-stretchable.

It is still a further object of the invention to provide a tarp having a strength and construction useful for truck tarp applications, but having a weight below 15 ounces per square yard.

It is yet a further object of the present invention to provide a method for manufacturing large, flexible, laminate sheets of tarps satisfying some or all of the above objects, the method providing the capability to produce large sheets quickly and efficiently from readily available rolls of fabric, yet providing an evenly applied bonding layer throughout the laminate, and substantially uniform thickness.

### SUMMARY OF THE INVENTION

Most truck tarps are 20 oz. to 28 oz. laminates. The high weights are due to strength and weathering requirements, as these tarps must maintain mechanical integrity under substantial strain and under conditions of severe weathering, and truck tarp failure can result in substantial problems. The are 20 oz. to 28 oz. laminates are very difficult to manage due to the high weight. A low weight laminate tarp that has the physical properties and weathering resistance necessary for use in a truck tarp is described herein. This laminate is, of course, also useful in the formation of articles such as garments, tarpaulins, tents, and the like.

One embodiment of the invention has a laminate including, as counted from a side of the laminate, a first polymeric layer of a first polymer or polymer blend that is resistant to UV and weathering degradation, a layer of a textile material, a second polymeric layer of an adhesive comprising a second polymer or polymer blend, and a third polymeric layer that is applied as a preformed film, and that may or may not comprise a formulation similar to the a second polymer or polymer blend. In alternate embodiments, the laminate may contain an extra adhesive layer and polymeric film layer, which can provide increased toughness and/or resistance to weathering. In another embodiment, the tarp may include an extra polymeric layer similar to the first polymeric layer of a first polymer or polymer blend that is resistant to UV and weathering degradation, where this additional layer is disposed exterior to the third polymeric layer. In all embodiments, a heat-weldable foourth layer ia advantageously included on one or both exterior surfaces of the laminate tarp.

In one embodiment, the tarp is a laminate that includes a scrim or textile material, having two sides, having a layer of a first polymeric adhesive on a first side, and a layer of polymeric film overlaying and bonded to the layer of adhesive, while on the second side is applied a curable layer of a different polymer.

In a preferred embodiment, titled a very-low-weight truck tarp, the laminated tarps described herein have a normalized weight below about 13 oz. per square yard, more preferably between about 8 and about 12 oz. per square yard, for example between about 9 and about 11 oz. per square yard, and also has strength and weatherability to be used in truck-tarp applications. In another embodiment, titled a low-weight truck tarp, the laminated tarps described herein have a normalized weight below about 16 oz. per square yard, more preferably between about 13 and about 15 oz. per square yard, for example between about 13 and about 14 oz. per square yard, and also has strength and weatherability to be used in truck-tarp applications.

In a first preferred embodiment the product is a laminate truck-grade tarp consisting of, counting from one side to the other side of the laminate, the following:

optionally a thin fourth polymeric layer, advantageously comprising a thermoplastic urethane and optionally an anti-stick agent, for example a organo-silicon compound;

a third polymeric layer, advantageously made of a pre-formed polymeric sheet and having superior anti-wear and anti-rip properties, comprising for example a preformed and pre-cured thermoset polyurethane film, as opposed to an applied un-cured polymeric layer;

a second polymeric layer, advantageously having strong adhesion both to the third polymeric layer and to a textile, and advantageously comprising an uncured water-curable thermoset polyurethane applied by spreading a thin layer over a fabric and cured during lamination with the third layer;

a textile, advantageously a woven nylon or nylon-polyester blend;

a first polymeric layer, advantageously having strong adhesion to the textile, and having excellent UV and weather resistance, and preferably comprising vinyl, more preferably a blend of vinyl and PVC polymers and/or copolymers; and

optionally a thin fourth polymeric layer, advantageously comprising a thermoplastic urethane and optionally an anti-stick agent, for example a organo-silicon compound. Advantageously, when the laminated tarp is manufactured, the layers are added to the textile/textile laminate in numerical order of the first, then the second, then the third, and then the fourth polymeric layers.

In a second embodiment the product is a polyurthane-reinforced low-weight laminate truck-grade tarp comprising, counting from one side to the other side of the laminate, the following:

optionally a thin fourth polymeric layer, advantageously comprising a thermoplastic polymer and optionally an anti-stick agent, for example a organo-silicon compound;

a third polymeric layer, advantageously made of a pre-formed polymeric sheet and having superior anti-wear and anti-rip properties, comprising for example a preformed and pre-cured thermoset polyurethane film, as opposed to an applied un-cured polymeric layer;

a second polymeric layer, advantageously having strong adhesion properties, and advantageously comprising an uncured water-curable thermoset polyurethane admixed with thermoset or thermoplastic polymers, for example polyacrylates, applied by spreading a thin layer over a textile and cured during lamination with the third layer;

a textile, advantageously a woven nylon or nylon-polyester blend;

a first polymeric layer, advantageously having strong adhesion properties, and having excellent UV and weather resistance, and preferably comprising vinyl, more preferably a blend of vinyl and PVC polymers and/or copolymers;

optionally a thin fourth polymeric layer, advantageously comprising a thermoplastic urethane and optionally an anti-stick agent, for example a organo-silicon compound; and

further include a fifth polymeric layer with a composition and/or adhesive properties similar to the second polymeric layer and disposed on the outside of the third polymeric layer, and a sixth layer of a pre-made polymeric film which may or may not be of a similar composition and properties of the third polymeric layer, where the sixth polymeric layer is disposed exterior to the fifth polymeric layer and interior to the optional fourth polymeric layer. Advantageously the fifth and sixth layers comprise a urethane adhesive and a preformed urethane film, for added toughness. Advantageously, when the laminated tarp is manufactured, the layers are added to the textile/textile laminate in numerical order of the first, then the second, then the third, then the fifth, then the sixth, and then the fourth polymeric layers.

In a third embodiment the product is a weather-resistant laminate truck-grade tarp consisting of, counting from one side to the other side of the laminate, the following:

optionally a thin fourth polymeric layer, advantageously comprising a thermoplastic polymer and optionally an anti-stick agent, for example a organo-silicon compound;

a seventh layer advantageously having strong adhesion properties, and having excellent UV and weather resistance, and preferably comprising vinyl, more preferably a blend of vinyl and PVC polymers and/or copolymers;

a third polymeric layer, advantageously made of a pre-formed polymeric sheet and having superior anti-wear and anti-rip properties, comprising for example a preformed and pre-cured thermoset polyurethane film, as opposed to an applied un-cured polymeric layer;

a second polymeric layer, advantageously having strong adhesion properties, and advantageously comprising an uncured water-curable thermoset polyurethane admixed with thermoset or thermoplastic polymers, for example polyacrylates, applied by spreading a thin layer over a textile and cured during lamination with the third layer;

a textile, advantageously a woven nylon or nylon-polyester blend;

a first polymeric layer, advantageously having strong adhesion properties, and having excellent UV and weather resistance, and preferably comprising vinyl, more preferably a blend of vinyl and PVC polymers and/or copolymers;

optionally a thin fourth polymeric layer, advantageously comprising a thermoplastic urethane and optionally an anti-stick agent, for example a organo-silicon compound. The addition of the vinyl layer exterior to the third polymeric layer would provide a weather-resistant UV-resistant vinyl layer anterior to the polyurethane layer, and would protect the second and third polymeric layers from degradation by weathering. Advantageously, when the laminated tarp is manufactured, the layers are added to the textile/textile laminate in numerical order of the first, then the second, then the third, then the seventh, and then the fourth polymeric layers.

### DETAILED DESCRIPTION OF THE INVENTION

As used herein, all compositions are expressed as weight percent of the solid material used in the ingredients. It is obvious that, after curing, the ingredients may not exist in the same form in the resultant polymer, due to crosslinking, polymerization, and other reactions known to occur during curing processes.

As used herein, a fabric an a coating weights are in ounces per square yard (oz.). A 4.6 oz. fabric therefore has a weight of about 4.6 ounces per square yard. A polymeric layer spread where the solid weight, after curing, is 0.2 ounces per square yard is said to be a 0.2 oz. polymeric layer. A tarp that is a 12 oz. laminate has an average weight of about 12 ounces per square yard of the single laminate. By single laminate this excludes areas containing seams and such wherein the fabric may be doubled over or reinforced, or areas where grommets exist, and the like.

Most applications of laminated fabric require a certain minimum strength. As used herein, tarp that is a truck tarp must have a fabric with a tensile (grab) strength per ASTM Method D 5034-90 of about 200×200 pounds minimum. The grab tensile method is used to evaluate breaking force and elongation at that breaking point. The fabric is clamped in a gripping jaw, where the front jaw face of the clamp measures 1 inch perpendicular to the direction of an applied force and 2 inches parallel to the direction of the applied force. The back jaw face of each clamp measures 3 inches perpendicular to the direction of the applied force and 2 inches parallel to the direction of the applied force. A specimen is selected that has a yam running the complete length of the sample. A 6.0 ounce uniform tension clamp is applied to one of the 4.0 inch edges chosen as the bottom. The specimen is then stretched to failure. See ASTM Standard D 5034-90 and Federal Standard 191A, method 5100. The truck tarp must have an adhesion of at least one laminate to the fabric that is at least 8 pounds per on a one inch strip. Further, the initial failure is advantageously delamination between a polymeric layer and a the fabric layer.

As used herein, tarp that is a truck tarp must have at least one polymeric layer laminated thereto that has a tear strength of at least 400 pounds per inch, a yeild strength of about 140 sf/pound per 1 ml thickness, and a modulus at 300% elongation of at least 3000 psi. Such a layer will provide required strength and tear-resistance to the laminate.

In one embodiment, the tarp is a laminate that includes a scrim or textile material, having two sides, having a layer of a first polymeric adhesive on a first side, and a layer of polymeric film overlaying and bonded to the layer of adhesive, while on the second side is applied a curable layer of a different polymer.

In one embodiment, the tarp is a laminate that includes a scrim having two sides, having a layer of a polymeric adhesive on a first side, and a layer of polymeric film overlaying the layer of adhesive, while on the second side is applied a layer of a different polymer, and also including a layer, preferably a thin layer, of thermoplastic polymeric material disposed on at least one side of the tarp.

In one embodiment, the tarp is a laminate that includes a scrim having two sides, having a layer of a curable polyurethane adhesive on a first side, and a layer of polyurethane film overlaying the layer of adhesive, while on the second side is applied a layer of a vinyl (co)polymer, and also optionally including a thin layer of thermoplastic polyurethane material disposed on at least the polyurethane film, but preferably on both sides of the multi-layered tarp.

In another embodiment, the tarp is a laminate that includes: a layer of woven or unwoven scrim or textile material, having two sides and advantageously comprising nylon fibers; a layer of a first polymeric material, preferably thermosetting, disposed on a first side of the scrim or textile material, which first material advantageously includes an at least partially crosslinkable vinyl (co)polymer, particularly an at least partially crosslinkable vinyl halide (co)polymer; a layer of a second thermosetting polymer adhesive material disposed on a second side of the scrim or textile material, advantageously as an independently curable/crosslinkable film and advantageously including an aromatic polyurethane, particularly an aromatic poly(urea) or poly(urethane-urea) formed by moisture curing an aromatic isocyanate-functional material; a layer of a third thermoset polymer material disposed upon the second thermoset polymer material, advantageously crosslinkable and adhesive to the second thermoset polymer material on the second side of the scrim or textile material, the third thermoset material advantageously including a polyurethane copolymer film, particularly a thermosetting one, i.e., a poly(ether urethane) copolymer film; and an optional layer of a fourth thermoplastic material disposed over the third thermosetting material layer and optionally over the first polymeric material layer as well, thereby substantially coating both sides of the laminate, the fourth material advantageously including a non-crosslinked, water-based, thermoplastic polyurethane, thermoplastic polycarbonate, or a mixture or copolymer thereof, and optionally also including a silicon-containing slip agent mixed therewith, applied in a patterned or random manner, or applied as a coating over the thermoplastic layer.

Textile Layer

A laminated tarp according to the invention begins with a layer of textile material, e.g., a so-called scrim in the form of a fabric mat or mesh, which can be fabricated in any form (e.g., fiber, yarn, woven fabric, or the like, or combinations thereof) to advantageously provide biaxial strength, tear resistance, limited flexibility (e.g., retaining a generally desired degree of stiffness and resistance to plastic deformation), and overall mechanical stability to the finished product. For the purposes of the present invention, textile fabrics include, for example, woven fabrics, knitted fabrics, and bonded and unbonded non-wovens. The textile fabrics may be made from synthetic and/or natural fibers.

The term “fabric” and “textile”, as used interchangeably herein, refers to a base substrate of fiber, whether woven, non-woven, knitted or braided, made from natural and/or synthetic fibers, and upon which various polymers are applied by coating, dipping, laminating, or by other suitable means. The terms fiber, yarn, filament, staple and fabric are well known to those skilled in the textile art.

This invention is applicable to any suitable fabric material, including acetate, polyester, polypropylene, nylon, rayon, cotton, fiberglass, acrylic, cellulose, polyethylene, polyvinyl chloride, polycarbonate, polyurethane, polyester polyurethane, polyethylene terephthalate, ARAMID (TM), and the like.

The invention is particularly applicable to polyester polyurethanes, polyesters, and to nylons. In principle, textiles made from any desired fibers are suitable for the process according to the invention. However, nylon or nylon blends are most preferred. Polyester is a suitable material since it does not absorb oils or water, but it has strength limitations compared to nylon. When using a vinyl-based first layer and a urethane-based second layer, it was found that 5.5 oz. per yard polyester had only marginal resistance to tearing. Nylon is more resistant to tearing, and is preferred though it costs more per yard than polyester. Cotton has wicking and mildew-related problems. Other synthetic pose adhesion problems to PVC, and/or are not cost competitive.

Blends of synthetic fibers can be used to obtain desired textile properties, as is known in the art. A blend may include polyester, polypropylene, or/or one or more of several nylons, for example nylon 12, nylon 715, or nylon 6. The fabric materials may be nylon, polyester and nylon tricot knit for instance. For example, tarpaulins are deficient in protecting against pilferage because they are easily cut with knives or razors, so incorporating a cut-resistant fabric, for example by leno or gauze weave, may be beneficial. The leno or gauze weaves are well known. For example, see: Corbman, B. P., Textiles: Fiber to Fabric, Sixth Edition, McGraw-Hill Inc., NYC, N.Y., 1983, pp. 94-95; Dictionary of Fiber and Textile Technology, Hoechst Celanese Corporation, Charlotte, N.C., 1980, p. 88.

The filling yarns (picks) may interlace with the warp yarns (ends) in different patterns to form different weaves. But the most common weave is one in which the filling yarns are essentially perpendicular to the warp yarns. In a preferred embodiment the textile has a pattern of intersecting warp yarns and filling yarns that intersect at approximately 90 degree angles. The warp yarns run lengthwise in the woven fabric, parallel to the selvages, a selvage being the edge of a fabric that is woven so that it will not fray or ravel. The filling yarns run from selvage to selvage at approximately right angles to the warp.

In one embodiment, the textile material in the scrim includes a type 715 nylon material or a hydrophilic nylon 6, preferably woven for strength and abrasion resistance; however, knitted or nonwoven polyamide polymers or copolymers may also be used.

While there is no absolute range limit to the possible warp and fill fiber size that can be utilized, the best results employing the invention method will be achieved with a warp fiber size between about 100 to 1800 denier and a fill fiber size between about 100 to 1800 (g/m) denier. The denier is a measure of fiber fineness which is typically measured in mass per length.

In a preferred embodiment, the normalized weight (measured according to ASTM D 3776-96, Option C) of the scrim or textile material is from about 2.5 to about 6.5 ounces per square yard, preferably from about 3 to about 6 ounces per square yard, for example from about 3.5 to about 5.5 ounces per square yard, such as from about 4.3 to about 4.8 ounces per square yard. In another preferred embodiment, the scrim or textile material has a denier value from about 700 to about 1400, preferably from about 750 to about 1200, more preferably from about 840 to about 1050. In another preferred embodiment, the scrim or textile material exhibits a bow and a skewness (each measured according to ASTM D 3882-96) each not more than about 3.5, preferably each not more than about 3, alternately each not more than about 2.5, for example not more than about 2.3 and about 2, respectively. In another preferred embodiment, the scrim or textile material exhibits an average percent shrinkage (measured according to the parameters detailed below) of not more than about 15%, preferably not more than about 11%, alternately from about 3% to about 12%, for example from about 7% to about 11%.

The average percent shrinkage in a fabric can be measured according to the following method. A 12-inch square specimen is conditioned for not less than about 4 hours by scouring and heat setting. A 10-inch square section is then marked therein. The fabric specimen is then freely suspended from one edge of the square in a hot air circulating oven for about 1 hour at a temperature of about 320 degrees F. Following this step, the specimen is again conditioned for not less than about 4 hours. The marked section is re-measured in three warp locations and three fill locations. Average percent shrinkage is expressed as an average of the percent change in the three measurements in each direction.

A preferred textile material in the scrim consisting of a type 715 nylon material or a hydrophilic nylon 6 or a blend thereof, preferably a type 715 nylon material; a weight per ASTM Method D 3776-96, Option C, of between about 3.8 and about 5.6 ounces per square yard, more preferably between about 4.35 and about 4.85 ounces per square yard; between about 600 and about 1200 denier, for example an warp of 840 and filling of 1050 denier plain weave; a tensile (grab) strength per ASTM Method D 5034-90 of about 250×245 pounds minimum; where the bow and skew per ASTM Method D3882-96 is 3% and 3% maximum, respectively, and preferably 2.3% and 2% maximum, respectively; where shrinkage is a one foot square sample suspended on one edge at 320 degrees F. for 1 hour is 12% maximum, preferably 10.5% maximum. Preferably the textile is thin, so that the first and the second layers can contact one another at low weight loadings. A preferred gauge, per ASTM Method D 1777-96, is between about 0.005 and about 0.017 inches, preferably between about 0.009 and about 0.013 inches. Advantageously there is no sizing applied, and the textile is beneficially, from a cost standpoint, in greige state. For an optimum production process, the laminate is made from rolls about 60 to 80 inches in width.

Advantageously, from a cost standpoint, the fabric is cleaned and scoured, but is not bleached, dyed, or otherwise treated. One exception may be to pre-treat the fabric to minimize polymeric material intrusion into fiber crossing points. The undesired bonding of fiber crossing points by added polymers may be avoided if the textile fabric is treated with aqueous dispersions of organic binders that are then coagulated. Alternatively, a pretreatment by a amine curing agent is useful, especially with a polyurethane-based adhesive, for example as is described in my co-pending application Ser. No. 09/919,803 titled LAMINATE COMPOSITE FABRIC filed Aug. 2, 2001, the contents of which are incorporated herein by reference. In one embodiment, the curing agent comprises a primary or secondary alkyl amine, preferably a primary alkyl diamine or alkyl tri-amine. In another embodiment, the curing agent comprises a primary or secondary ether amine or alkyl ether amine. In a preferred embodiment, the curing agent comprises a primary or secondary amine, preferably a primary amine, disposed on a secondary carbon. The amine is thereby sterically hindered, slowing any curing reaction. In a more preferred embodiment, the curing agent comprises a polyetheramine, for example a poly(oxypropylene)amine. In another preferred embodiment, the curing agent comprises an average of 1.5 or more amine functional moieties per molecule of curing agent. In a more preferred embodiment, the curing agent comprised an average of 2 amine moieties per molecule of curing agent. In an even more preferred embodiment, the curing agent comprises at least 2.5 amine functional moieties, for example three functional amine moieties, per molecule of curing agent. A preferred curing agent comprises a poly(oxypropylene) di- or tri-amine. Having at least a portion of the curing agent comprise a tri-amine provides a thermosetting fixative. While the curing agent may react with the adhesive prior to pressure-laminating the thermoplastic to the fabric, it is preferred that at least a portion of the curing agent react with at least a portion of the adhesive during the pressure lamination step. Coated textile fabrics produced in this manner are characterized by increased tensile strength and greater softness.

Multi-layered scrim constructions are alternatively contemplated, for example a three layer product wherein a (co)polymer film is flanked by layers of textile material on first and second sides, where the respective sides are then treated as described herein. The fabric may be woven from yarns, or in some instances the fabric may be formed into a ribbon, and then the ribbon can be woven into a fabric. However, this significantly increases fabric weight. Discussion of multiple scrim layers as if discrete is intended to cover this construction, i.e., a plurality of textile layers adhered to one another being treated as a single scrim or textile material.

To obtain good adhesion between the fiber and the binder, it is necessary for the first polymeric layer material to wet the fabric. Liquids with a high surface tension normally will not wet a substrate well. Substrates of a low surface energy are not easily wetted, and vice versa. For example, pure water, having a high surface tension, often requires the addition of a surfactant to reduce surface tension and enhance wetting. In some embodiments a surfactant is added to the first used in the polymerization process will function in this manner.

Synthetic fibers such as polypropylene have a low surface energy and as a consequence are much more difficult to wet and adhere to, unlike cellulose, which has a higher surface energy. For this reason, many synthetic fibers are treated (sized) to improve wetting.

First Polymeric Layer

On one side of the scrim or textile material, a first polymeric layer is added. The character of this first layer can advantageously be selected to provide good weathering properties, a certain amount of flexibility, good compatibility with and adhesion to the scrim or textile material layer, some level of flame retardance, generally acceptable chemical stability and weather resistance in ambient environmental conditions, or a combination of such properties. This first polymeric layer, according to the principles of the invention, is a vinyl-based polymer layer.

In one embodiment, the first polymeric layer includes a vinyl halide polymer and/or copolymer, e.g., with the halide being chloride (such as PVC or a PVC copolymer). In a preferred embodiment, the first polymeric layer is a thermosetting material which may or may not include a separate crosslinking agent and/or a curing agent, wherein a thermoset material is created upon curing of the layer, e.g., upon exposure to an external energy source, such as under increased temperature conditions. In another preferred embodiment, the first polymer layer may include a plasticizer component, especially to facilitate uniform spreading of the layer, to facilitate accelerated curing and/or crosslinking of the polymer film, to facilitate contact with (and preferably adhesion to) the scrim or textile material, to adjust the viscosity of the layer for application to the scrim or textile material, or to provide for a combination of these effects.

In one preferred embodiment, the first polymeric layer includes a mixture of a vinyl-based homopolymer and a vinyl-based copolymer, especially a mixture of a vinyl halide homopolymer and a copolymer containing vinyl halide-containing monomers (e.g., in combination with an acrylic acid and/or acrylate salt monomer). The use of ethylene-vinyl acetate as an additive may provide enhanced adhesion to the fabric.

In another preferred embodiment, the first polymeric layer further contains a plasticizer or a mixture of plasticizers, especially a mixture of aliphatic diacid bis(alkyl ester)s and aromatic diacid n-alkyl esters (e.g., hexyl, octyl, and/or decyl esters of phthalic acid). Adipates are also known plasticizers useful in this invention.

In another preferred embodiment, the first polymeric layer may alternatively or additionally contain: an antioxidant component, e.g, including triphenyl phosphite; a UV protector, e.g., including carbon black; a coloring agent or pigment; one or more solvents, preferably to be substantially driven off or evaporated during formation of the multi-layered tarp; or the like; or a combination thereof. A preferred UV protector is carbon black, which, when used, is present advantageously at about 1% to about 4% by weight, preferably from about 2% to about 3% by weight.

In another preferred embodiment, the first polymeric layer further contains a crosslinking and/or curing agent to react with the (co)polymeric material in order to crosslink the polymeric material and/or to further thermoset the first polymeric layer material. In this preferred embodiment, one exemplary crosslinking and/or curing agent includes a formaldehyde or urea-based resin, particularly a urea-formaldehyde resin, such as a glycoluril-formaldehyde resin.

Advantageously, the viscosity of the first material can be such that total penetration and/or wetting of the scrim or textile material does not occur.

In a preferred embodiment, the normalized weight of the first polymeric layer is from about 1 to about 6 ounces per square yard, preferably from about 2.5 to about 5 ounces per square yard, for example from about 3.2 to about 4.5 ounces per square yard, such as about 3.9 ounces per square yard. This provides a ultra-light tarp.

In another embodiment, the normalized weight of the first polymeric layer is from about 4 to about 9 ounces per square yard, for example from about 5 to about 7 ounces per square yard. This heavier tarp may be useful in certain environments.

The first polymeric layer material is advantageously a vinyl- or PVC-based formulation that is applied at a rate of between 2.5 and 8 ounces per square yard, preferably between 3 and 6 ounces per square yard, for example between 3.5 and 4.5 ounces per square yard. This is a much lower weight application than is normally added to truck tarps. Without being bound to theory, it is believed that the other layers in the laminate provide substantial and sufficient strength to the laminate despite the low weight of these other layers, and the method of construction provides a strong adhesion of this first layer to both the fabric and to the second layer, thereby reducing the required amount of the first layer when compared to conventional truck tarps.

Advantageously, the PVC may be admixed with a vinyl-acrylic acid copolymer. Comonomers which may be considered are vinyl esters of carboxylic acids having 1 to 18 carbon atoms, particularly vinyl acetate and vinyl propionate, vinyl chloride, and vinylidene chloride; vinyl ethers such as vinyl methyl ether; vinyl ketones such as vinyl ethyl ketone; and heterocyclic monovinyl compounds such as vinyl pyridine. Suitable vinyl aromatic monomers are those in which the vinyl group is directly attached to the ring consisting of 6 to 10 carbon atoms. Examples of vinyl aromatics include styrene and substituted styrenes such as 4-methylstyrene, 3-methylstyrene, 2,4-dimethylstyrene, 4-isopropylstyrene, 4-chlorostyrene, 2,4-dichlorostyrene, divinylbenzene, alpha-methylstyrene and vinylnaphthalene. Up to 25% by weight of the monomers may be replaced by one or more copolymerizable monomers, particularly by (meth)acrylic acid alkyl esters, such as methyl, ethyl, propyl, isopropyl, butyl, isobutyl, and 2-ethylhexyl (meth)acrylate; mono- and diesters prepared from alkanediols and alpha,beta- -monoethylenically unsaturated monocarboxylic acids, such as ethylene glycol mono(meth)acrylate, propylene glycol mono(meth)acrylate, ethylene glycol di(meth)acrylate, and 1,4-butanediol di(meth)acrylate; amides of alpha, beta.-monoethylenically unsaturated mono- and dicarboxylic acids, such as acrylamide and methacrylamide and the N-methylol compounds thereof, together with N-alkoxymethyl(meth)acrylamides and N-acyl(meth)acrylamides having 1 to 4 carbon atoms in the alkyl groups such as N-methoxymethyl(meth)acrylamide, N-butoxymethyl(meth)acrylamide and N-acetoxymethyl(meth)acrylamide. Monomers bearing sulfonic acid groups are also suitable, such as styrenesulfonic acid, (meth)allylsulfonic acid, or the water-soluble salts thereof.

A preferred first polymeric layer material includes:

between about 30% and about 42%, for example about 34% to 35% of a crosslinkable vinyl (co)polymer, particularly a crosslinkable vinyl halide (co)polymer, for example poly(vinyl chloride)-acrylic acid copolymer having a formula: (C₃H₄O₂.C₂H₃Cl)ₓ identified as CAS Registry No.: 25702-80-1, such as POLYONE (TM) Vinyl available from Geon Canada Ltd., Niagara Falls, Ontario. Advantageously, poly(vinyl chloride) resins burn with difficulty, and the smoke generated when poly(vinyl chloride) resins burn is within the narrow limits of toxicity of the smoke from all commonly used materials. The primary toxic combustion products are carbon monoxide and hydrogen chloride;

optionally, between about 5% and 10%, for example between 7% and 9%, of a polyvinylchloride (PVC) monomer and/or homopolymer, CAS Registry No.: 9002-86-2, such as VC 1071 (TM) PVC HOMOPOLYMER available from BORDEN CHEMICALS AND PLASTICS. PVC homopolymers are not reactive with water or light under normal ambient conditions, although discoloration may occur with exposure to light unless stabilizers are used in manufacture;

optionally between about 0.5% and 5%, for example about 2 to 3% of a modified glycoluril-formaldehyde resin;

optionally between about 0.5% and 5%, for example about 2 to 3% of a plasticizer-pigment concentrate, advantageously comprising carbon black;

between about 40% and about 60%, for example between about 45% and 50%, of a polymerizable plasticizer, for example an alkyl phthalate plasticizer, which may advantageously include one or more of 1,2-benzenedicarboxylic acid, di-n-octyl phthalate, di-n-hexyl phthalate, di-n-decyl phthalate, such as is available from Aristech Chemical Corp of Pittsburg Pa.;

optionally between about 1% and about 6%, for example about 3% and 5%, of a second polymerizable plasticizer, for example azelaic acid, bis (2-Ethylhexyl) ester (103-24-2); undecanedioic acid, bis (2-Ethylhexyl) ester (38717-66-7); suberic acid, bis (2-Ethylhexyl) ester (122-62-3); adipic acid, bis (2-Ethylhexyl) ester (103-23-1), or mixture thereof, preferably azelaic acid, bis (2-Ethylhexyl) ester such as is available as EDENOL 9058 DOZ (TM) PLASTICIZER or PLASTOLEIN 9058 (TM) available from Henkel Corp.

optionally between about 0.1% and 3%, for example between 0.7 and 1.3%, of an antioxidant, for example a phosphite, preferably a triphenyl phosphite such as PLASTISTAB 2334 available from OMG AMERICAS, INC. of Franklin Pa.

This first layer is advantageously applied to a first side of the textile with, for example, a knife, and is then cured prior to application of the second polymeric layer. Preferably this first polymeric layer at least partially invades the voids between the fabrics to prevent the second polymeric layer from penetrating too far into the textile and thereby giving undesired stiffness.

There are many types of materials that can be added to the vinyl-based copolymer formulation to provide enhanced or unique properties. Post-formulation add-ons are used to improve film strength, modify the surface characteristics, impart flame retardancy, add color, reduce latex cost and fulfill a range of other requirements. Strength enhancers can be added to increase crosslinking. Surface modifiers can be added to make the surface of the cured vinyl more or less wettable. Surfactants can improve the wetting properties as well as the processing. Hydrophobes in the form of fluorochemicals, polyolefins or silicone derivatives can be added to reduce the wetting characteristics. Low-cost fillers can be used to reduce the cost of the product, and some fillers are functional as well, such as activated carbon black. The first polymeric layer can be formulated to resist flame, mildew, UV, and abrasion as is known in the art.

In some embodiments, the first polymeric layer may comprise one or more vinyl sub-layers laminated one over another where the copolymer formulation, or the type or quantity of additives, varies between sublayers. For example, the sublayer nearest the fabric may have additives to increase strength or adhesion, and the sublayers further from the fabric may have additives to increase resistance to UV, mildew, or the like, or to alter wettability. It is beneficial in such instances to apply the sublayers one over another before the layers are fully cured to insure there is sufficient binding strength between sublayers.

Second Polymeric Layer

The laminate contains a second polymeric layer disposed on the textile on the side opposite of the first polymeric layer. On the side of the scrim or textile material opposite that on which the first polymeric layer is disposed, this second polymeric layer is added. The character of this second layer is advantageously be selected to provide good adhesive properties with a third layer disposed upon it, good compatibility with the scrim or textile material layer, some level of flame retardance, generally acceptable chemical stability, or the like, or a combination of such properties.

The adhesive may be chosen to be compatible with the third polymeric layer film. These layers may be united, or laminated, in a variety of ways, for instance by heat treatment or through adhesive effects. For example, if a nylon film is used for a third polymeric layer, a nylon-based adhesive may be used in the second polymeric layer. The adhesive to be used depends both on the composition of the copolyether amide and the type of textile material. Generally favorable results are obtained by using a fusible polyamide as the adhesive for polyamide textile materials and films. Similarly, a fusible polyester would be expected to perform well with a polyester textile material and film. A polyurethane adhesive is useful for polyurethane textiles and film. Surprisingly, it has been found that certain polyurethane adhesives perform well with nylon textile material, particularly if some solvents are initially present in the adhesive.

This second polymeric layer is preferably a polyurethane-based, polyurea-based, or poly(urethane-urea)-based primer layer. For the purposes of the invention, the term “polyurethanes” also includes polyurethaneureas, poly(urethane-urea)s, and polyureas. Polyurethanes may be prepared in a known manner in a melt or, preferably, in an organic solvent.

In one embodiment, the second polymeric layer includes a prepolymer containing diisocyanates and optionally triisocyanates or higher-functionality polyisocyanates. In a preferred embodiment, the second polymeric layer is a thermosetting material or includes a crosslinking agent or a curing agent, such that a thermosetting material is readily created upon crosslinking or curing of the layer, e.g., if not upon contact between the curative/crosslinking agent and the prepolymer, then upon exposure to an external energy source, such as under increased temperature conditions. In another preferred embodiment, the second polymer layer may include a solvent component, especially to facilitate uniform spreading of the layer, to facilitate accelerated curing and/or crosslinking of the polymer film, to facilitate contact with (and optionally adhesion to) the scrim or textile material and optionally also to the first polymeric layer, to adjust the viscosity of the layer for application to the scrim or textile material, or to provide for a combination of these effects.

U.S. Pat. No. 6,303,731, the disclosure of which is incorporated by reference, describes moisture curable polyurethane compositions. A moisture curable composition that includes a polyurethane prepolymer comprising the reaction product of a) a polyol having an unsaturation of less than 0.02 meq/g; and b) a polyfunctional isocyanate, where the composition forms a pressure sensitive adhesive when cured, is disclosed.

Suitable diisocyanates for use in preparing the polyurethane prepolymer include 2,4- and 2,6-toluene diisocyanate, 1,4-phenylene diisocyanate, naphthylene diisocyanate, diphenylmethane diisocyanate, alpha.,.omega.-alkylene diisocyanates such as hexamethylene diisocyanate, and isophorone diisocyanate. Preferred isocyanates include diphenylmethane diisocyanate isomers and oligomers thereof. Some polyisocyanates can be used, particularly in the second polymeric layer where thermosetting polymer is desired. These include triphenylmethane triisocyanate, and aliphatic di-, tri- and polyisocyanates are also useful including, for example, isophorone diisocyanate, hydrogenated aromatic diisocyanates, aliphatic polyisocyanates and cycloaliphatic polyisocyanates.

Isocyanate-reactive compounds for reaction with the polyisocyanates are principally polyhydroxyl compounds which have 2 to 15 (preferably 2 to 4) hydroxyl groups per molecule and an (average) molecular weight of up to about 5,000. Both low molecular weight polyhydroxyl compounds having molecular weights of 32 to 349 and higher molecular weight polyhydroxyl compounds having average molecular weights of at least 350 (preferably at least 1,000) may be considered for this purpose. Higher molecular weight polyhydroxyl compounds include the hydroxypolyesters, hydroxypolyethers, hydroxypolythioethers, hydroxypolyacetals, hydroxypolycarbonates, and/or hydroxypolyesteramides that are known in polyurethane chemistry, preferably such compounds having average molecular weights of 1,00 to 25,000.

Suitable polyols may be any oligomers that can be prepared with hydroxy terminal groups, for example polycarbonates, polyesters, silicone materials, polyhydroxyalkylacrylates, polyhydroxyalkylmethacrylates, elastomeric materials such as polybutadiene diacrylate and polyepoxy materials. Other examples of suitable urethane oligomers include urethane acrylates or substituted urethane acrylates such as urethane acrylate with ethoxylated trimethylol propane triacrylate or urethane acrylate with 2-(2-ethoxyethoxy)ethyl acrylate). Polycarbonate polyols, polyether polyols, and polyester polyols are in many applications preferred.

This second layer is advantageously an uncured water-curable thermoset adhesive. By thermoset it is meant that the adhesive is substantially crosslinked. While a thermoplastic adhesive could in theory be incorporated into the second layer, thermoset adhesives are preferred. In some embodiments, some thermoplastic (i.e., non-crosslinkable) adhesive is incorporated into the thermoset adhesive to give additional softness or other specialized properties. The second polymeric layer material can be a mixture of crosslinkable or non-crosslinkable polymers. This adhesive layer is preferably crosslinkable polyurethane-based, and may additionally or alternately contain other polymers, such as polyacrylates, polyurethanes, poly(acrylic acid)s, polybutadienes, polyvinyl acetates, and/or vinyl chloride/vinyl acetate copolymers, phenolic (co)polymers, or blends or copolymers thereof, provided the adhesion is not sufficiently disrupted. There are conditions where tarps in storage or in use can get hot, however, and thermoplastic adhesives may weaken unacceptably. Thermoset adhesives are therefore preferred.

As stated, the moisture curable composition can also include a thermoplastic polymer to impart improved film-forming characteristics to the composition. The thermoplastic polymer is advantageously selected to be compatible with the moisture curable composition including, e.g., the polyol of the composition. See, for example, U.S. Pat. Nos. 4,775,719; 4,808,255; 4,820,368; and U.S. Pat. No. 5,411,808. Exemplary useful thermoplastic polymers include thermoplastic polyurethane polymers, ethylene acrylate copolymers, ethylene vinyl acetate copolymers, ethylene methyl acrylate, ethylene n-butyl acrylate copolymers, ethylene n-butyl acrylate carbon monoxide terpolymers, butylene/poly(alkylene ether)phthalates, acrylic polymers, and polyvinyl methyl ether polymers. A preferred thermoplastic component is thermoplastic polyester urethane. These thermoplastic polymers may be present from about 0% to about 50% by weight of the resultant moisture cure polyurethane composition, preferably no greater than about 30% by weight of the moisture curable composition, for example from about 5% to about 20% by weight of the composition.

The moisture curable composition can also include a plasticizer. The plasticizer can be added to alter a variety of properties of the cured and uncured composition including such properties as, e.g., extrudability, flexibility, workability and stretchability, or a combination thereof. Preferred plasticizers are compatible with the cured adhesive composition, and exhibit low volatility. The plasticizer is selected such that it does not react with components of the moisture curable composition. Useful plasticizers are organic and include liquid resins, liquid elastomers, polybutene, polyisobutylene, phthalate and benzoate plasticizers including for example dicylcohexylphthalate and pentaerythritol tetrabenzoate, and epoxidized soya oil. Plasticizers such as olefin oligomers and low molecular weight polymers can also be used. Plasticizers or oils having —OH functionality or —COOH functionality may react with the components of the moisture cure system causing undesirable results. These plasticizers may be present from about 0% to about 20% by weight of the resultant moisture cure polyurethane composition, preferably no greater than about 10% by weight of the moisture curable composition, for example from about 1% to about 5% by weight of the composition.

The adhesive may optionally also contain an antioxidant, a fiber reinforcement, another filler material, or the like, or a combination thereof.

The polyols are generally reacted with the isocyanate compounds at ratios that typically depend on the hydroxy and isocyanate functionality of the reactants. Typically the compounds are reacted at ratios that result in a reaction between isocyanate groups and hydroxy groups leaving essentially no residual hydroxy and minimal isocyanate functionality. While the choice of component, order of addition and addition rate can be left to one of skill in the art, generally the reactive polyurethane compositions of this invention can be made by reacting the isocyanate and the polyols and then blending with the thermoplastic component and any other optional ingredient that may be added. Optionally, the thermoplastic component can be blended with the polyols before reacting with the isocyanate.

In one preferred embodiment, the prepolymer of the second polymeric layer includes a mixture of aromatic diisocyanates or isomers of a single aromatic diisocyanate and a low molecular weight polyurethane oligomer made from the reaction product of a diisocyanate, e.g., an aromatic diisocyanate, optionally a triisocyanate or higher-functionality polyisocyanate, and a polyether/polyester diol/triol/polyol compound having a moderate molecular weight. In one embodiment, the polyurethane oligomer may be a poly(ether-urethane) having a molecular weight between about 5,000 and about 40,000 g/mol, alternately between about 10,000 and about 20,000 g/mol.

In another preferred embodiment, the second polymeric layer can contain a crosslinking and/or curing agent to react with the (co)polymeric material in order to crosslink the polymeric material and/or to render the second polymeric layer a thermosetting material. In this preferred embodiment, one exemplary crosslinking and/or curing agent includes a mixture of aromatic diisocyanates and/or triisocyanates and/or higher-functionality polyisocyanates (i.e., molecules having 4 or more isocyanate functional groups), and higher order oligomers of these preferred aromatic diisocyanates (and/or triisocyanates and/or higher-functionality polyisocyanates). For example, the crosslinking/curing agent may include a mixture of methylene-4,4′-bis(phenyl isocyanate) (MDI) and 2,2′ and/or 2,4′ oligomers, in combination with a high-temperature-stable isocyanate-based construct, such as dimer (4-membered ring) or a trimer (6-membered ring) formed from MDI monomers, and/or in combination with the reaction product of a diisocyanate, e.g., an aromatic diisocyanate, optionally a triisocyanate or higher-functionality polyisocyanate, and a polyether or polyester (preferably polyether) diol/triol/polyol compound having a moderate molecular weight. In one embodiment, the polyurethane oligomer may be a poly(ether-urethane) having a molecular weight between about 5,000 and about 40,000 g/mol, alternately between about 10,000 and about 20,000 g/mol. In another preferred embodiment, the polymeric material is cured by addition of a curing agent, typically water in the form or water vapor, mist, steam, or the like. Without being bound to theory, it is believed that the water reacts with the free isocyanate groups (—N═C═O) to form carbamic acid groups (or —NH—COOH), which are unstable. These carbamic acid groups can decompose, releasing CO₂, to form amine groups (—NH₂), which are very reactive with the remaining unreacted isocyanate groups, thus forming a polyurea-type structure and/or a poly(urethane-urea)-type structure.

It is also possible to incorporate crosslinking additives which do not react with themselves or the binder until the coating is complete, generally under the action of heat. These compounds include blocked polyisocyanates with 3 and more isocyanate groups, such as those based on tris(isocyanatohexyl) isocyanurate and tris(isocyantohexyl)biuret, polyepoxides, and polyaziridines.

In another preferred embodiment, the second polymeric layer further optionally contains: a UV protector, e.g., including carbon black; a plasticizer or a mixture of plasticizers; a coloring agent or pigment; one or more solvents, preferably to be substantially driven off or evaporated during formation of the multi-layered tarp; or the like; or a combination thereof.

In a preferred embodiment, the second polymeric layer material is advantageously a polyurethane-based or polyurea-based formulation that is applied at a rate of between 0.2 and 2 ounces per square yard, for example between 0.5 and 1.5 ounces per square yard. In another embodiment, the second polymeric layer material is advantageously a polyurethane-based or polyurea-based formulation that is applied at a rate of between 2 and about 5 ounces per square yard, for example between 2.5 and 3.5 ounces per square yard. This heavier application of adhesive may be useful in some environments.

A preferred second polymeric layer material includes:

between about 3% and about 10% of a crosslinker, advantageously a crosslinker that additionally acts as a water-activated curing agent, for example a polyisocyanate, for example between about 3% and about 7% of isocyanic acid, polymethylenepolyphenylene ester, also known as polymeric diphenylmethane diisocyanate, comprising for example a mixture of 4,4′-Diphenylmethane Diisocyanate (MDI), Diphenylmethane Diisocyanate (2,2;2,4), and between 20% and 70% of higher oligomers of MDI such as is available as MONDUR MR-200 available from Bayer Corp of Pittsburgh Pa. Of course, an excess of di-isocyanates can also function as a crosslinker;

optionally between about 0.1% and about 4% of a second isocyanate formulation, for example between about 1.5% and about 3% of, for example a second aromatic isocyanate formulation admixed with a solvent, for example methyl ethyl ketone;

between about 60% to about 95%, for example between about 85% and about 95%, of a isocyanate-curable polyol, for example a urethane-based adhesive formulation admixed with a solvent such as methyl ethyl ketone. The polyol in this preferred embodiment can be polyester, polyethers, polycarbonates, or mixtures thereof. A portion or all of the polyol can be replaced by a polyamine with a functionality not less than two, i.e., diamine, or triamine.

optionally the second polymeric layer comprises solvent. The solvent, for example MEK, dimethylformamide, dimethylacetimide, tertrahydrofuran or mixtures thereof, particularly dimethylformamide, advantageously present in an amount between 1% to 40%, for example between 10% and 30% by weight, of the second layer polymeric formulation. This solvent appears to increase the adhesion of the layer to a nylon fabric;

optionally between about 0.1% and about 4% of a second isocyanate formulation, for example between about 1.5% and about 3% of a plasticizer-pigment concentrate, advantageously comprising carbon black.

Advantageously, the viscosity of this second polymeric layer is between about 4000 and about 25000, preferably between about 9000 to 15000, centipoise, so that the second layer does not significantly penetrate the textile as it is applied to the textile with a knife. The tarp in softer in feel if the thermoset polyurethane adhesive does not penetrate too many of the fiber crossing points of the textile. It has been found important in making soft tarps to avoid impregnating the fabric, especially the bonding fiber crossing points, with the second layer, particularly if the second layer consists essentially of polyurethane. Advantageously, the first polymeric layer, which comprises softer vinyl-based, i.e., PVC-based, polymers, is placed on the fabric first and binds to the bonding fiber crossing points. The viscosity of the second polymeric layer, plus the presence of the cured or partially cured first polymeric layer, prevents the second layer polyurethane from substantially binding together fabric fiber crossing points. Without being bound by theory, this may avoid a loss of flexibility and the risk that the bond between the textile fibers and binder will be broken under flexural stress. By having the first layer be applied before the second layer, the first layer will penetrate the textile material and physically prevent the second polymeric layer material from penetrating into the textile by an undesired amount. The viscosity can be varied by, for example, adding solvents.

We have surprisingly found that solvents, for example polar solvents, i.e., MEK, dimethylformamide, dimethylacetimide, tertrahydrofuran,dimethyl sulfoxide, N-substituted pyrrolidone such as N-methyl-2-pyrrolidone (NMP), sulfolanes, and the like, or mixtures thereof, particularly dimethylformamide, advantageously present in an amount between 1% to 40%, for example between 10% and 30% by weight, of the second layer polymeric formulation improve adherence of the second polymeric layer to the fabric and the first polymeric layer. The inventors surprisingly found that for the second polymeric urethane layer, made for example of EX-00459 with 5% RCO-1739, gives over 10 pounds of adhesion on a 1 inch strip. This result was achieved only after DMF solvent was incorporated into the formulation. Without being bound to theory, it is believed that this solvent softens up the outer layer of the textile fabric, the boundary layer of the first polymeric layer, or both, thereby increasing the number of covalent bonds between the second polymeric layer and the textile and/or first polymeric layer.

Beneficially the solvents are removed from the formulation, by for example heating, prior to applying the third polymeric layer. While this second polymeric layer is described as thermoset, in preferred embodiments heat alone advantageously does not cure the adhesive. Rather, the adhesive is cured by addition of another component, for example water, after the solvent has been driven out of the second polymeric layer. The amount of this component, beneficially water or preferably steam, added just prior to adding the third layer is beneficially kept to a minimum. Limiting the amount of water added as, for example, by exposing the uncured polyurethane adhesive to steam as opposed to admixing water into the adhesive, lengthens the curing time. The second polymeric layer may be cured for 24 or 48 hours. However, this results in a cooler curing process, and allows generated gases to escape though the layers without tending to delaminate the tarp.

Third Polymeric Layer

The third polymeric layer is laminated over the second polymeric layer. Advantageously, this third polymeric layer is applied as an integral sheet. Such a sheet is easy to manufacture without defects, while a sheet formed on the tarp may have defects such as cracks. If there are cracks in the polymer film, they will reduce its strength and render chemical crosslinking ineffective.

Materials used in these films may include polytetrafluoroethylene, polyurethanes, polypropylene, polyester, nylon, and so forth. The manufacture of the films from polymers, for example polyurethanes or copolyether amides, may be carried out in any manner known to the art. For example, the film blowing process or flat die extrusion may be used to produce films. Advantageously the polymeric film is crosslinked, i.e., thermoset. The film may be nonoriented or orientated.

If a nylon fabric is bonded to a nylon film of say 0.5 mil thickness by means of a fusible nylon scrim fabric, the laminating is performed by bringing the fabric, scrim and film together under pressure, and heating the assembly until the scrim melts to form a bond between the fabric and film, as is well known in the art, e.g. under pressure of about 2000 psig and a temperature of about 150 degrees C.

If non-crosslinkable thermoplastic such as polypropylene film is used, a UV stabilizer is preferably added so that the polypropylene is unaffected by light once it is manufactured into the laminate. Without this stabilizer, the polypropylene may break down, change color, or do both. A UV stabilizer is generally not used with a cross-linked thermoplastic, since it is naturally more resistant to the effects of UV rays.

The third polymeric layer material is preferably a polyurethane-based or polyurea-based formulation that is applied as a pre-formed film, preferably a rate of between 0.2 and 2 ounces per square yard, for example between 0.5 and 1.5 ounces per square yard. A one mil thick polyurethane weighs approximately one dry ounce per square yard. A preferred embodiment had the weight of the second and third polymeric layers combining to give a added weight of about 1.3 to 2.5 ounces per square yard, for example 1.8 ounces per square yard.

Similarly, a fifth and sixth layers, if included, may combine to give a added weight of about 1.3 to 2.5 ounces per square yard. Or, a thicker film may be used to reduce the number of processing steps.

On the side of the scrim or textile material opposite that on which the first polymeric layer is disposed and on the same side as the second polymeric layer, this third polymeric layer is added. The character of this third layer can advantageously be selected to provide good adhesive properties with a second layer upon which it is disposed, good heat resistance properties, some level of flame retardance, generally acceptable chemical stability (e.g., to hydrolysis, fungal or microbial attack, etc.), or the like, or a combination of such properties.

This third polymeric layer, according to the principles of the invention, is preferably a pre-formed layer that is added to the second adhesive layer as an already fabricated film. In a preferred embodiment, the third polymeric layer is a thermoset polyurethane-based film. In this preferred embodiment, one exemplary type of film includes an aromatic poly(ether-urethane) copolymer, e.g., such as commercially available under the PT9600 series tradename from Deerfield Urethane, Inc. (a division of Bayer Corp.), of South Deerfield, Mass. The thickness of the third layer film can advantageously be from about 0.001 inches to about 0.06 inches, alternately from about 0.001 inches to about 0.009 inches or from about 0.001 inches to about 0.06 inches. In one preferred embodiment, the thickness of the third layer film is as small as possible, i.e., about 1 mil or less, in order to advantageously keep the normalized weight of the multi-layered tarp as low as possible while attaining as many beneficial properties of the third layer material as possible in the finished product.

A 1 mil film such as an AROMATIC POLYETHER POLYURETHANE FILM/SHEET available from Deerfield Urethane. Inc. of South Deerfield, Mass., is a preferred third polymeric layer. The film advantageously is abrasion resistant, with a Durometer (Shore A) hardness of between about 80 and 100. The film is advantageously strong, with an Ultimate Tensile strength of at least 7000 psi. The film advantageously is stretchable, with an Ultimate Elongation of at least 200%, preferably 300%, wherein the Modulus @ 100% elongation is 1850 psi(MD) or 1600 psi (CD). The film advantageously is tear resistant, with a tear strength of at least 400 lb/in.

Polyurethanes are the preferred class of materials for this film. If selected correctly, polyurethanes can be very tough and tear resistant and can have moderately good weatherability characteristics.

In another preferred embodiment, the normalized weight of the combination of the second primer/adhesive layer plus the third polymeric film layer is from about 0.6 to about 2.8 ounces per square yard, preferably from about 1 to about 2.3 ounces per square yard, for example from about 1.5 to about 2 ounces per square yard, such as about 1.8 ounces per square yard.

Crosslinked polyurethane film thickness can be up to ten mils, preferably less than 5 mils, with the thicker sheets giving greater strength but also greater weight and stiffness. Thicker film may optionally have a fabric, for example a nylon reinforcing fabric, embedded therein. Often, however, the required thickness and the fabric results in a tarp that is too stiff for customer acceptance. Sheets of thickness of 0.5 mil to 2 mil mils are most preferred.

Other Optional Polymeric Layers

Advantageously, fifth, sixth, and seventh layers are not present, as they add weight and additional manufacturing steps to the tarp. The tarps of the present invention are beneficial primarily because they provide the required performance with low weight and low cost, including manufacturing costs and material costs.

The fifth and sixth layers, if present, can be formed out of the same materials as the second and third layers. Alternatively, a thicker application of the second polymeric layer and the selection of a thicker third polymeric layer film can provide added strength. The fifth and sixth layers may, however, be of a different formulation, for example a polyurethane formulation which incorporates additional fillers such as UV protectants, antioxidants, pigments, and the like not present or present in different quantities than are present in the second and third layers.

The seventh polymeric layer, if present, advantageously is vinyl-based and/or PVC based. This layer, in one embodiment, comprises a formulation similar to the formulation of the first polymeric later.

A treatment on the exterior side of the third polymeric layer may be needed to provide adequate adhesion to a vinyl formulation. A small layer of a formulation similar to the adhesive of the second polymeric layer may be applied to provide this effect, though the viscosity may be reduced.

Fourth Polymeric Layer

Advantageously, a very thin layer of thermoplastic polymer, preferably including a thermoplastic polycarbonate (co)polymer, a thermoplastic polyurethane (co)polymer, or a combination thereof, is added to one or both sides. The fourth polymeric layer is a very this application of a thermoplastic polymer over the third polymeric layer, over the first polymeric layer, or both. If more layers are present the fourth layer(s) are beneficially disposed on the exterior surfaces of the laminate.

Advantageously, a multi-layered tarp according to the invention also includes a fourth layer of polymeric material disposed as a coating over the third layer film material (on the second side of the scrim or textile material), and optionally also disposed as a coating over the first layer material (on the first side of the scrim or textile material). The character of this fourth layer can advantageously be selected to be thermoplastic, to facilitate adhesion between overlappping tarp sections during welding/joining, (in some instances) to provide anti-sticking and/or anti-blocking character, to provide good compatibility with the third layer film (and optionally with the first layer material), to provide increased wear resistance for the third layer film (and optionally the first layer material), and to provide generally acceptable chemical stability (e.g., to hydrolysis, fungal or microbial attack, etc.), or the like, or a combination of such properties. The fourth layer is typically so thin that it is applied by either spraying or dipping. This layer can advantageously make the tarp surface capable of being sealed or joined to itself or to another tarp surface. Two surfaces on either side of the scrim of textile material, each containing this fourth layer material, should exhibit enhanced weldability. It is preferred that the fourth layer is present as a very thin coating over one or both external layers of the tarp, advantageously such that the thickness of each layer (if present on both sides) is less than about 0.5 ounces per square yard, preferably less than about 0.4 ounces per square yard, for example from about 0.01 to about 0.3 ounces per square yard, such as about 0.05 or about 0.2 ounces per square yard. It is also preferred that the fourth layer material be a thermoplastic material and therefore uncrosslinked.

In a preferred embodiment, the fourth layer of polymeric material is applied as a water-based polymer, preferably a water-based thermoplastic polymer, more preferably a water-based thermoplastic polyurethane copolymer. In this embodiment, one exemplary water-based polyurethane copolymer is a polycarbonate-based polyurethane copolymer, e.g., such as one commercially available under the tradename EX-62-994 from Stahl USA of Peabody, Mass.

In another preferred embodiment, the fourth layer of polymeric material optionally further includes a slip agent and/or a wetting agent. In this embodiment, the slip agent can advantageously include a silicon-containing compound, e.g., an organosilicon compound such as an alkylated silica, particularly a methylated silica. In this embodiment, when the optional wetting agent is present, the optional wetting agent can advantageously include one or more organic solvents, especially those solvent containing one or more hydroxyl groups, and a surfactant, e.g., an alkyl-sulfonated metal ion-containing salt of an organic acid, such as a metal alkyl sulfosuccinate.

Each external surface of the fourth layer of polymeric material, whether disposed on one or both sides of the laminate, can advantageously be roughened, either randomly or in a patterned manner, e.g., through an embossing process. This roughening of the surface may serve to reduce the surface area for contact with an external material or with another layer, and thus may advantageously prevent or inhibit undesired adhesion of the water-based fourth polymeric material (e.g., to itself, to an uptake mechanism, etc.) during layer formation and/or during subsequent handling of the multi-layered tarp. It is unexpected, however, that such a roughening does not significantly affect the ability of the fourth layer to be, for example, heat-sealed or RF welded to itself, regardless of whether it is disposed on the third polyurethane film or the first vinyl-based layer, which sealability/weldability is a key property in the fabrication of commercial tarps.

The fourth polymeric layer(s) is advantageously a polyurethane-based or polyurea-based formulation that is applied at a rate of between 0.02 and 0.4 ounces per square yard, for example between 0.05 and 0.15 ounces per square yard.

A preferred fourth polymeric layer material includes:

about 90% to 100% of a water-based polyurethane and/or polyurea polymer or prepolymer, such as EX-62-994 available from Stahl USA of Peabody Mass., with 32% solids in selected solvents such as n-methylpyrrolidone which may aid in adherence to the outer layer;

optionally about 0.1% to 5% of a wetting agent to ensure coverage of the exterior sides of the laminate, for example LA-1610 Wetting Agent available from Stahl USA; and

optionally about 0.1% to 20%, for example 2% to 4%, of a anti-sticking agent which advantageously comprises organosilicon compounds, such as trialkyl silicas, for example HM-354 available from Stahl USA.

As the fourth layer(s) are thin, they can be formulated to be radiation-curable or heat-curable. This thin layer is of sufficient quantity to allow for secure welding, if desired, of overlaying pieces of the tarp, upon application of sufficient energy, e.g., in standard or known thermal or RF welding techniques. Advantageously, a matte finish can be applied to prevent or inhibit sticking or blocking.

General Properties

Advantageously, at least the adhesive layer material and polyurethane film, as well as optionally the first vinyl-based layer, disposed on the scrim or textile material are substantially crosslinked. These crosslinkable layers provide added strength in the finished product and added adhesion between layers. The tarp can advantageously include a very thin fourth layer of a thermoplastic polymer disposed on the exterior of at least one, and preferably both, sides of the multi-layered tarp.

Advantageously, in one embodiment, neither the first curable polymer layer nor the second curable polymer layer is substantially present on both sides of the scrim or textile material, i.e., each curable polymer is present only on a single (its own) side of the scrim or textile material. If any layer protrudes through the textile, it should be the first polymeric layer, i.e., the vinyl-based layer. This provides a designed weakness such that, if the stress on the tarp approaches the tear strength, the tarp should thus partially delaminate at the interface between one of these layers and the scrim or textile material. If failure is at the interface between the second curable layer material and the scrim or textile material, failure allows added stretchability and thereby decreases the stress on the tarp without catastrophically tearing, which might result in the tarp flying off the truck, possibly on a highway.

It is preferred that, when the multi-layered tarp according to the invention is subject to stresses to the point of failure, that the multi-layered tarp is designed so that inevitable failure should optimally occur by partial delamination, preferably with the second layer delaminating from the scrim or textile material. In this manner, catastrophic tearing can advantageously be avoided. According to the principles of the invention, each layer-layer and layer-textile interface preferably exhibits a resistance to delamination up to a tearing force of at least about 10 pounds per 1-inch strip. The tearing force of the laminate should be higher, so that the lowest resistance to tearing is preferably along the interface between: the second layer and the scrim or textile material, the first layer and the scrim or textile material, or both.

According to the present invention, it may be desired to include additives to one or more of the layers of the tarp, which additives may include but are not limited to antioxidants, antiozonants, UV protectors, hydrophilic agents, hydrophobic agents, pore-forming agents, pigments, reinforcing fillers, plasticizers, solvents, catalysts, additional curing agents, additional crosslinking agents, biocides, wettability agents, or the like, or a combination thereof.

Advantageously, each of the multi-layered tarps of this invention has a normalized weight below about 15 oz. per square yard, preferably below about 12 oz. per square yard, for example below about 10 oz. per square yard. In an alternate preferred embodiment, the multi-layered tarp has a normalized weight between about 9 and about 12 oz. per square yard, for example between about 10 and about 12 oz. per square yard. Despite the relatively low normalized weight, the multi-layered tarp has excellent strength, weatherability, and tear resistant properties, and was specifically designed for use as a truck tarp.

In one preferred embodiment, the tarp contains a scrim comprising nylon or polyamide-based (co)polymer fibers and having two sides, a first layer of vinyl (co)polymer on the first side, while on the second side is applied a second layer of a moisture-curable polyurethane adhesive on the second side, and a layer of polyurethane film overlaying this layer of adhesive. Advantageously, each of the above-mentioned three polymer layers are substantially crosslinkable (thermosetting), and the tarp further comprises a very thin layer of a thermoplastic polyurethane on the exterior of at least one, and preferably both, sides. Advantageously, the tarp has a weight below 15 oz. per square yard, preferably below about 12 oz. per square yard, more preferably between about 9 and about 12 oz. per square yard, for example between about 10 and about 12 oz. per square yard.

Additionally or alternatively, anti-oxidants, UV protectants, and the like, or combinations thereof, can be incorporated in one or in all layers, or may be added as an outer finish to one or to all layers.

Method of Manufacture

Another aspect of the present invention relates to a method of forming a multi-layered tarp, such as described above.

The method of manufacturing the laminate tarp comprises the twelve steps of:

1. providing a textile, for example a nylon scrim;

2. optionally sizing or pretreating the textile;

3. spreading a first (co)polymer formulation, for example a PVC-based formulation, on a first side of the scrim or textile;

The chemical nature and chemical and physical characteristics of an exemplary first polymer layer material are disclosed above and herein, which first polymer layer contains homopolymers, copolymers, or both, wherein the monomer repeat unit(s) are preferably vinyl or vinyl-based. Examples of such first layer materials include, but are not limited to, vinyl polymers, vinyl chloride polymers, vinylidene chloride polymers, vinyl fluoride polymers, vinylidene fluoride polymers, (meth)acrylic acid polymers, (meth)acrylate polymers, and the like, and blends or copolymers thereof. This first polymer layer may be disposed, advantageously spread, onto the first side of the scrim or textile material using, e.g., a floating knife, in order to apply a relatively uniform thickness. In one embodiment, the viscosity of the first primer layer material can be from about 800 to about 15,000 cps, more preferably from about 2,000 to about 10,000 cps, alternately from about 4,000 to about 6,000 cps.

4. substantially curing this first (co)polymer formulation;

The scrim or textile material with the first polymer layer material disposed on a first side can then be dried, devolatilized, cured, crosslinked, or a combination thereof, e.g., such that the first primer layer material is thermoset, for example, by exposure to an external energy source, such as under increased temperature conditions. In one embodiment, the thermosetting occurs above about 250 degrees F., preferably above about 300 degrees F., for example from about 350 degrees F. to about 450 degrees F., such as at about 400 degrees F. The extent of time for which the scrim or textile material with the first primer layer material disposed on its first side is heated can change, depending upon factors such as the temperature, the amount of solvent present (if any), and/or the reactivity of the crosslinking and/or curing agents, inter alia, i.e., the higher the thermosetting temperature, the shorter the thermosetting time, and vice versa. In this embodiment, the thermosetting can advantageously occur for about 10 seconds to about 5 minutes, more preferably from about 25 seconds to about 2 minutes, alternately from about 30 seconds to about 1 minute. For an automated or continuous process, less than about 3 minutes thermosetting time is preferred.

5. spreading an adhesive, for example a solvent-containing water-curable crosslinkable polyurethane, to a second side of a scrim to form a second polymeric layer;

The chemical nature and chemical and physical characteristics of an exemplary second polymer layer material are disclosed above and herein. The polymer in this second layer is beneficially a water-cure polyurethane prepolymer, which in some embodiments may be admixed with other polymers, oligomers, additives (e.g., poly(meth)acrylates, styrenics, phenolics, styrene-butadiene copolymers, urethane-styrene copolymers, urethane-acrylate copolymers, or the like, or copolymers thereof) and the like, or combinations thereof. On a second side of the scrim or textile material, opposite that first side on which the first polymeric layer should be disposed, this second polymer layer may be disposed, advantageously spread onto the second side of the scrim or textile material using, e.g., a floating knife, in order to apply a relatively uniform thickness, as described above. In one embodiment, the second polymer layer material contains at least one organic solvent, e.g., a ketone such as methyl ethyl ketone (MEK), preferably such that viscosity of the second polymer layer material can be from about 200 cps to about 30000 cps, preferably from about 5000 cps to about 20000 cps, for example from about 9000 cps to about 15000 cps.

6. heating the laminate to drive off substantially all of the solvent;

The scrim or textile material with the second polymer layer material disposed on the second side can then be dried and/or devolatilized, e.g., at a temperature ranging from ambient to an increased temperature, such as below about 200 degrees F., preferably above about 70 degrees F., alternately from about 100 degrees F. to about 150 degrees F., for example at about 125 degrees F. The extent of time for which the scrim or textile material with the second polymer layer material disposed on its second side is heated can change, depending upon factors such as the temperature and the amount of solvent present, inter alia, i.e., the higher the drying/devolatilization temperature, the shorter the drying/devolatilization time, and vice versa. In this embodiment, the drying and/or devolatilization can advantageously occur for about 10 seconds to about 5 minutes, more preferably from about 25 seconds to about 2 minutes, alternately from about 30 seconds to about 1 minute.

7. applying a curing agent to the adhesive;

Upon being sufficiently dried and/or devolatilized, and while within the desired temperature range, the scrim or textile material with the second primer layer material disposed on the second side can then be exposed to a curing and/or crosslinking agent to render the second polymeric layer a thermosetting material. In a preferred embodiment, where the second primer layer includes a mixture of isocyanate-functional groups, one exemplary crosslinking and/or curing agent includes water, typically in the form or water vapor, mist, steam, or the like. Without being bound to theory, it is believed that the water reacts with the free isocyanate groups (—N═C═O) in the layer material to form carbamic acid groups (—NH—COOH), which are unstable. These carbamic acid groups can decompose (and generally do so relatively quickly, especially at increased temperatures), releasing CO₂, to form amine groups (—NH₂), which are very reactive with the remaining unreacted isocyanate groups, thus chain extending the isocyanate-functional compounds to form a polyurea-type structure.

8. overlaying the adhesive layer containing the curing agent with a third polymeric layer, for example a pre-fabricated crosslinked polyurethane film, by applying pressure to force the film onto the adhesive;

Advantageously, after the second polymer layer has been has been exposed to the curing agent (e.g., preferably by exposure to steam) but before the end of the second polymer layer thermosetting process (e.g., usually before substantial thermosetting has taken place), and preferably still while within the desired temperature range, the second polymer layer material disposed on the second side of the scrim or textile material is then contacted with a third polymeric layer. Preferably this third polymeric layer is a pre-formed layer to be adhered to the second polymer layer as an already fabricated film.

The chemical nature and chemical and physical characteristics (including, inter alia, the thickness/normalized weight thereof) of an exemplary third layer material are disclosed above and herein. Advantageously, this polymer layer contains a polyurethane. Additional polymers, copolymers, fillers, and/or stabilizers may optionally be incorporated into this layer. This polymeric film may be homogeneous or may have many heterogeneities due to fillers, copolymers, etc., substantially only on one side of the film (e.g., on the side of the film facing the second polymer layer or on the side of the film furthest from the second polymer layer).

9. allowing the adhesive to cure, while optionally applying increased temperatures and pressure to further bond the laminate and to optionally but preferably form a matte surface on at least one side of the laminate;

In order to attain sufficient adhesion between the second polymer layer and the third polymeric film layer, the multi-layered structure may advantageously be subject to increased pressure, typically while heated, to more fully strengthen the laminate material. The extent of time for which the multi-layered structure is subject to increased pressure can change, depending upon factors such as the temperature, the level of thermosetting/curing of the second polymer layer, the compatibility between the second and third layer materials, the amount of residual solvent present, etc., or a combination thereof. In one embodiment, the increased pressure can be applied for about 10 seconds to about 3 minutes, more preferably from about 15 seconds to about 1 minute, alternately from about 20 seconds to about 40 seconds.

It may be desirable to allow the scrim or textile material with the second polymer layer material and third polymeric layer film disposed on the second side to sit, or age, for a period of time, e.g., to allow for sufficient and/or substantial curing of the layers disposed on the scrim or textile material, and optionally but preferably for sufficient adhesion of these layers to each other and/or to the scrim or textile material. The extent of time for which the multi-layered structure is subject to aging can vary, depending upon a number of factors such as the temperature, the amount of solvent present, and the compatibility between the second and third layer materials, the amount of crosslinking/curing agent (e.g., water) added, and the like, or any combination thereof. In one embodiment, the aging can occur for about 12 hours to about 96 hours, preferably for about 18 hours to about 84 hours, for example for about 24 hours to about 72 hours, such as for about 48 hours.

10. optionally adding one or more of a fifth, sixth, or seventh polymeric layer, and curing these layers while optionally applying increased temperatures and pressure to further bond the laminate and to optionally but preferably form a matte surface on at least one side of the laminate;

11. applying a very thin layer of a fourth polymeric layer, i.e., a thermoplastic polymeric layer containing for example a thermoplastic polycarbonate (co)polymer, a thermoplastic polyurethane (co)polymer, a polyacrylate copolymer, a fusible nylon copolymer, or a combination thereof, to one or both sides of the laminate;

To the multi-layered structure can then be added a fourth polymeric layer material. This material may be disposed only on one side of the multi-layered structure, i.e., disposed over the third polymeric layer film, but is preferably disposed over both sides of the multi-layered structure, i.e., disposed over both the third polymeric layer film and over the first primer layer. This addition of the fourth material can advantageously be accomplished in any suitable manner. For instance, when the fourth material is to be disposed or coated over both sides of the multi-layered structure, the multi-layered structure may be dipped into, or submerged within, a vessel containing the fourth layer material. The chemical nature and chemical and physical characteristics (including, inter alia, the thickness/normalized weight hereof) of an exemplary fourth layer material are disclosed above and herein.

Importantly, this layer is advantageously applied as a very thin coating, having a normalized weight between about 0.02 and about 1 ounce per square yard, preferably from about 0.05 to about 0.2 ounce per square yard, for example of about 0.1 ounce per square yard (i.e., per coated side). Advantageously, this fourth polymeric layer contains a polyurethane, a polyurea, or a copolymer or blend thereof. Other polymers or copolymers may also be incorporated, for example, organo-silicon polymeric/oligomeric material, poly(meth)acrylates, polyurethane-polyacrylate copolymers, polyurethane-poly(organosilicon-containing) copolymers, and the like.

12. allowing the adhesive to cure, while optionally applying increased temperatures and pressure to cure the fourth layer and to further bond the laminate and to optionally but preferably form a matte surface on at least one side of the laminate.

Optionally but preferably, the coated multi-layered structure may be subject to increased temperature and/or increased pressure, e.g., for a period of time sufficient to dry the material and/or evaporate volatile components (such as solvent(s), etc.) and to facilitate bonding of this fourth layer material to the third layer material, to the first layer material, or to both. If increased pressure is desired, the pressure may be applied, e.g., by rolling the coated multi-layered structure between two squeeze rolls. This applied pressure can advantageously serve to minimize the thickness of the fourth polymeric layer, to provide increased pressure to further facilitate adhesion between the previously deposited layers and/or with the scrim or textile material, to provide a more uniform coating, to create roughness or an embossed surface on one or more exterior layers, or any combination of these effects. When pressure is applied, the pressure can be from about 50 psi to about 1000 psi, preferably from about 75 psi to about 500 psi, alternately from about 100 psi to about 200 psi. Additionally or alternately, if increased temperature is desired, the applied temperature may be from about 250 degrees F. to about 450 degrees F., preferably from about 275 degrees F. to about 400 degrees F., for example from about 300 degrees F. to about 350 degrees F. The extent of time for which the coated multi-layered structure is exposed to heat and/or pressure can change, depending upon factors such as the temperature and/or pressure applied, the amount of solvent present (if any), and/or the viscosity (or desired molecular weight) of the fourth polymeric layer material, inter alia.

Of course, other methods can be used to apply various polymeric layers. While a preferred method of applying the first and second polymeric layers is by spreading with a knife, these layers can be applied by other means, such as extrusion, rolling, and even flow-coating or spraying. The fourth polymeric layer can be applied by immersion, by rolling, by spraying, or by other means. The third polymeric layer, in a less preferred embodiment, can be applied as an uncured layer, for example by extrusion or by blowing the film at the same time as adding the film to the laminate.

Solvents are generally minimized, as they add cost due to obtaining the solvent and to disposing of the solvent. However, solvent is preferred in the second polymeric layer, if the second polymeric layer is a water-curable polyurethane. This solvent is believed to create greater adhesion to the textile and to the first polymeric layer.

Heat is generally applied in ovens, and the temperature of the oven may be changed during the process. Of course, in a preferred automated process, the oven(s) have several distinct temperature zones which remain relatively constant, and the laminated material travels from one oven or temperature zone to another, thereby effectuating the temperature changes.

In a preferred embodiment rollers are used to move the fabric layers and also to provide pressure to the three or more combined layers to produce the final laminate. It is conceivable that other means may be used to move the fabric and also to provide the final pressure to produce the laminate. Rollers are a preferred means, and the pressures stated as being applied are only approximate, as the pressure applied will depend on the viscosity and thickness of the relative layers, the thickness of the textile and film, as well as other factors. Applying a pressure sufficient to create a strong bond, and to create a matte finish when desired, is within the skill of one of ordinary skill in the art.

The amount of polymer applied to the laminate is predetermined and is further dependent on the choice of fabrics e.g. the size of the fibers in the fabric layer(s), the characteristics of the polymers used for the first and second layers, and the like. The thickness of the fabric is determined by choice of fiber size, and the type of weave. The thickness of the first and second layers will be determined by the extent of interstitial spaces in the particular fabric, the amount of polymer applied, the viscosity of the heated polymers, and the pressure applied to the layer(s). Additionally, the amount of pressure applied in the final steps to the laminate also influences the bonding layer thickness and penetration of the polymers into the interstices of the fabric layers, even though these layers are thermoset, in part because pressure is applied before the second polymeric layer is totally cured.

As previously stated, optionally but preferably, each external surface of the fourth layer of polymeric material, whether disposed on one or both sides of the coated multi-layered structure, can advantageously be roughened, either randomly or in a patterned manner, e.g., through an embossing process to apply a matte-like appearance. This roughening of the surface may serve to reduce the surface area for contact with an external material or with another layer, and thus may advantageously prevent or inhibit undesired adhesion of the water-based fourth polymeric material (e.g., to itself, to an uptake mechanism, etc.) during layer formation and/or during subsequent handling of the multi-layered tarp.

Roughening may also increase the ability of the fourth layer to create a strong welded bond with another laminate, i.e., for heat-sealed or RF welded to itself or to the first primer layer, which sealability/weldability is a key property in the fabrication of commercial tarps.

The physical characteristics of the multi-layered tarps fabricated according to the method of the present invention (including, inter alia, the thickness/normalized weight thereof) are preferably as described above and herein. Advantageously, the multi-layered tarp fabricated according to the method of the present invention has a normalized weight below about 15 oz. per square yard, preferably below about 12 oz. per square yard, for example below about 10 oz. per square yard. In alternate preferred embodiments, the multi-layered tarp fabricated according to the method of the present invention has a normalized weight between about 9 and about 12 oz. per square yard, for example between about 10 and about 12 oz. per square yard. Despite the relatively low normalized weight, the multi-layered tarp fabricated according to the method of the present invention has excellent strength, weatherability, and tear resistant properties, and was specifically designed for use as a truck tarp.

### EXAMPLES

Exemplary embodiments of the present invention will be illustrated by reference to the following examples, which are included to exemplify, but not to limit, the scope of the present invention.

### Example 1

### A Multi-Layered Tarp According to the Invention

The multi-layered tarp of Example 1 contained five materials or layers, including a textile material, a first primer layer, a second adhesive layer, a third pre-fabricated film layer, and a fourth coating layer. Their dispositions within the multi-layered tarp and their compositions were as described below.

| Textile: | Type 715 Nylon fabric, | | |
|---|---|---|---|
| Properties: | 840 × 1050 denier; inherent twists of not more than about 1.5 turns per inch; | | |
| | plain weave; in greige state; normalized weight of about 4.6 ± 0.3 ounces per | | |
| | square yard; bow of not more than 2.3; skew of not more than 2; average | | |
| | percent shrinkage of not more than about 10.5; gauge (according to ASTM | | |
| | D 1777-96) of the body of the fabric of 11 ± 2 mils. | | |
| First polymer layer: | disposed on a first side of the textile material; normalized weight | | |
| | from about 2.1 to about 4.7 ounces per square yard, preferably from | | |
| | about 3.4 to about 4.4 ounces per square yard, more preferably of | | |
| | about 3.9 ounces per square yard, and including: | | |
| | modified glycoluril-formaldehyde resin | 9.3 | parts |
| | (CYMEL 1171 from Cytec Industries of Stamford, CT) | | |
| | Black pigment plasticizer paste | 9 | parts |
| | (Black Dispersion 22-2020 from P & D Color of Atlanta, GA) | | |
| | PLASTISOL primer* | 350 | parts |

*the composition of the primer is as follows:

| Component | Amount |
|---|---|
| PX-316 linear phthalate plasticizer | ˜51 wt % |
| (from ChemSolv, Inc., of Rock Hill, SC) | |
| Edenol 9058 DOZ plasticizer (PLASTOLEIN 9058) | ˜3.7 wt % |
| (from Henkel Corp. of Cincinnati, OH) | |
| PLASTISTAB 2334 triphenyl phosphite stabilizer | ˜0.9 wt % |
| (from OMG Americas, Inc., of Franklin, PA) | |
| VC-1071 poly (vinyl chloride) hompolymer | ˜8.4 wt % |
| (from Borden Chemicals & Plastics of Geismar, LA) | |
| GEON 137 poly (vinyl chloride-acrylic acid) copolymer | ˜36 wt % |
| (from Geon Canada, Inc., of Niagara Falls, Ontario) | |

| Second adhesive polymer layer: | disposed on a second side of the textile material | | |
|---|---|---|---|
| | (opposite side from the first primer layer), and | | |
| | including: | | |
| | polyurethane prepolymer (polyether, mw., ˜15,000) | 276 | parts |
| | (SA-262 from Worthen Industries, Inc., of Nashua, NH) | | |
| | isocyanate-functional crosslinking/curing agent | 15 | parts |
| | (RCO-1739 from Bayer Corp. of Pittsburgh, PA) | | |
| | Black pigment plasticizer concentrate | 6 | parts |
| | (Black Dispersion 22-2063 from P & D Color of Atlanta, GA) | | |
| | Water (steam) added to cure/crosslink | | |
| Third pre-fabricated film: | disposed over the second adhesive layer on the second side of | | |
| | the textile material (opposite side from the first primer layer), | | |
| | and including: | | |
| | aromatic poly (ether-urethane) film, | 1 | mil thick |
| | (PT9611 from Deerfield Urethane, Inc., of S. Deerfield, MA) | | |

The total normalized weight of the second and third layers was from about 0.3 to about 4.3 ounces per square yard, preferably from about 0.6 to about 2.8 ounces per square yard, more preferably about 1.8 ounces per square yard.

| Fourth coating layer: | disposed on both sides of the textile material (over the first | | |
|---|---|---|---|
| | primer layer and the third pre-fabricated film layer); total | | |
| | normalized weight of the coating from about 0.1 to about 0.3 | | |
| | ounces per square yard, preferably of about 0.2 ounces per | | |
| | square yard (i.e., about 0.1 ounces per square yard on each | | |
| | side of the laminated structure), the coating being applied as a | | |
| | solution of: | | |
| | Water-based poly (carbonate-urethane) copolymer | 248 | parts |
| | (EX-62-994 from Stahl USA of Peabody, MA) | | |
| | Wetting agent | 4.8 | parts |
| | (LA-1610 from Stahl USA of Peabody, MA) | | |
| | Silicone-containing slip agent | 8.3 | parts |
| | (HM-354 from Stahl USA of Peabody, MA) | | |

The final multi-layered tarp had a normalized weight of between about 9 and about 11.5 ounces per square yard, preferably from about 9.5 to about 11 ounces per square yard, alternately from about 10 to about 10.5 ounces per square yard.

The final multi-layered tarp also had strip tensile values (in pounds-force per inch/pounds-force per inch, as measured according to ASTM D-751-89) W/F from about 250 to about 375/from about 225 to about 350, preferably W/F from about 275 to about 350/from about 250 to about 325, alternately from about 310 to about 340/from about 270 to about 315.

The final multi-layered tarp further had a Mullen burst value and/or a Mullen hydro value (in pounds-force, as measured according to ASTM D-751-89 18.3, and in psi, as measured according to ASTM D-751-89 34.2) from about 500 to about 1000, preferably from about 650 to about 900, alternately from about 750 to about 875.

The final multi-layered tarp additionally had an adhesion value (in pounds per inch, as measured according to Federal Standard No. 191A 5970) from about 5 to about 9, preferably from about 6 to about 8, alternately of about 7.

The final multi-layered tarp exhibited Tabor abrasion values (in cycles to failure under a one-kilogram load, as measured according to ASTM-D-3389-94) on the vinyl-side of at least about 60, preferably at least about 75, alternately at least about 95 or from about 90 to about 150, and on the polyurethane-side of at least about 150, preferably at least about 175, alternately at least about 215 or from about 200 to about 300.

The final multi-layered tarp also exhibited grab tensile values (in pounds-force/pounds-force, as measured according to ASTM D-5034) W/F from about 350 to about 550/from about 350 to about 550, preferably W/F from about 400 to about 500/from about 400 to about 500, alternately from about 450 to about 525/from about 425 to about 500.

The final multi-layered tarp further exhibited tongue tear test values (in pounds-force/pounds-force, as measured according to ASTM D-2261) W/F of at least about 45/at least about 40, preferably W/F of at least about 50/at least about 45, alternately from about 60 to about 125/from about 55 to about 100.

### Example 2

### A Method of Fabricating a Multi-Layered Tarp According to the Invention

The method of Example 2 entailed fabricating a multi-layered tarp according to the compositions described in Example 1. The steps of the method were as follows.

First, the textile material was run under a floating knife to apply a coating of the first polymer layer composition to the first side of the textile material. The first polymer layer was then subject to about 400 degrees F. for about 30 seconds. Then, the second adhesive layer was run under a floating knife to apply a coating of the second polymer layer composition on the second side of the textile material (opposite from the first polymer layer side), which was then exposed to about 125 degrees F. in an oven to remove the MEK solvent and other volatile materials, for about 30 seconds. Just before the doubly-coated textile is removed from the heat, a fine mist steam was applied to the second polymer layer to activate the moisture-cure process. The structure was then lined up and contacted with the third pre-fabricated film and run through a rubber roll-steel roll to apply pressure. Once the third layer film is adhered, the structure was rolled up and aged for about 48 hours. After that, the multi-layered structure was submerged into a vessel containing the fourth layer material (in a low viscosity, e.g., a water-based, formulation) and squeezed between rolls. The coated structure was then placed into an oven at between about 300 degrees F. and 350 degrees F. for about 30 seconds. The coated tarp was then embossed on both sides to apply a roughened, or matte, appearance to the fourth coating layer. The materials used were as described in Example 1.

As above, the final multi-layered tarp made according to the method of Example 2 had a normalized weight of between about 9 and about 11.5 ounces per square yard, preferably from about 9.5 to about 11 ounces per square yard, alternately from about 10 to about 10.5 ounces per square yard, as well as the properties enumerated in Example 1 above.

Again, the strength and tear resistance of the tarp material, discounted by the weight, are central to this invention. It is essential to incorporate a fabric for ease of handling and for designed delamination as a relief from high stresses/strains. It is also essential that the tarp has adequate weatherability—the tarps discussed herein should be resistant to degradation by the sun, by water, and by chemicals. The first layer, containing a vinyl-based polymer and additives, is useful for enhanced weatherability and should be oriented face-out (i.e., vinyl-side up) when the tarp is placed on a truck. It is advantageous that the textile contain nylon fiber, for superior strength versus cost and weight. It is also advantageous that the third layer contain crosslinked polyurethane for increased wear resistance and tear resistance. Advantageously, the second polymer layer contains a urethane-based adhesive. Other polymeric adhesives, such as phenolic adhesives, formaldehyde resin adhesives (e.g., such as resoles, cresoles, other phenol-formaldehyde resins, urea-formaldehyde resins, and the like), epoxy-based resins, those adhesives sold under the tradename BYNEL® (commercially available from DuPont Chemical of Wilmington, Del.), or the like, can be used alternatively, or (if used at all) preferably as an added component to the polyurethane adhesive.

It will be readily apparent to those skilled in the art that various modifications may be made to the multi-layered tarp product, as well as to the method of manufacturing same, without departing from the spirit and scope of the invention. The scope of the invention shall not be limited to the embodiments described in the specification but, instead, shall be defined by the scope of the claims, as appended.

What is claimed is:

1. A laminate truck-grade tarp having a first side and a second side and a plurality of laminated polymeric layers, comprising:
optionally an interior fourth polymeric layer disposed on the first side and comprising a thermoplastic polymer;
a third polymeric layer contacting the optional fourth polymeric layer, if present, and also contacting a second polymeric layer, the third polymeric layer consisting of a pre-formed cross-linked polymer film;
a second polymeric layer contacting the third polymeric layer and also contacting a textile, the second polymeric layer comprising a crosslinked adhesive which was cured after contacting with the third layer and the textile, wherein the second polymeric layer adheres both to the textile and to the third polymeric layer with force sufficient to not delaminate under a force of 8 pounds per square inch;
a textile comprising a plurality of fibers and contacting the second polymeric layer and a first polymeric layer, wherein at least a portion of the fibers comprise polyamide polymers, polyamide copolymers, or a blend thereof;
a first polymeric layer comprising vinyl polymers and/or copolymers, vinyl halide polymers and/or copolymers, or a mixture thereof, wherein the polymeric material is substantially crosslinked, the first polymeric layer adheres to the textile with force sufficient to not delaminate under a force of 8 pounds per square inch, and the first polymeric layer is resistant to degradation by ultraviolet light; and
optionally an exterior fourth polymeric layer disposed on the second side and comprising a thermoplastic polymer, wherein at least one of the interior fourth polymeric layer and exterior fourth polymeric layer is present;
wherein the laminate truck-grade tarp has a normalized weight below about 13 oz. per square yard, a tensile (grab) strength of at least about 200×200 pounds per inch, and is suitable for use as a truck-grade tarp.

2. The laminate truck-grade tarp of claim 1, wherein
the first polymeric layer is between 2.5 and 8 ounces per square yard and comprises a vinyl chloride homopolymer and a copolymer containing vinyl halide-containing monomers;
the second polymeric layer is between 0.2 and 2 ounces per square yard of an adhesive comprising a water-cured substantially crosslinked polyurethane that was applied in uncured state in a formulation containing an organic solvent and was cured after contacting with the third polymeric layer;
the third polymeric layer is a pre-formed crosslinked film comprising polyurethane, polypropylene, polyester, or nylon, wherein the third polymeric layer has a tear strength of at least 400 pounds per inch, a yield strength of at least 140 sf/pound, and a modulus at 300% elongation of at least 3000 psi;
the at least one fourth polymeric layer is about 0.01 to about 0.3 ounces per square yard of a substantially uncrosslinked polymeric material comprising a thermoplastic polyurethane; and
the textile is a plain weave fabric of intersecting warp and fill fibers of between about 700 to about 1400 denier and having a normalized weight from about 2.5 to about 6.5 ounces per square yard, wherein at least some of the fibers comprise nylon 12, nylon 715, nylon 6, or mixture thereof.

3. The laminate truck-grade tarp of claim 1, wherein
the first polymeric layer is between 2.5 to about 5 ounces per square yard and comprises a mixture of a vinyl chloride homopolymer, a copolymer containing vinyl halide-containing monomers and acrylic acid-containing monomers, and a polymerizable alkyl phthalate plasticizer;
the second polymeric layer is between about 0.5 and about 1.5 ounces per square yard of a cured substantially cross-linked adhesive comprising, prior to curing: a water-curable mixture comprising
a) a polyol selected from polycarbonate polyols, polyether polyols, polyester polyols, or mixtures thereof,
b) a isocyanate selected from di-isocyanates and polyisocyanates, or mixtures thereof, and
c) between 1 and 40% by weight of the water-curable mixture of a solvent selected from methyl ethyl ketone, dialkylformamide, dialkylacetimide, tertrahydrofuran,dialkyl sulfoxide, an N-alkyl substituted pyrrolidone, a sulfolane, or mixture thereof, wherein the solvent is substantially removed from the cured adhesive, and wherein the cured second polymeric layer adheres both to the textile and to the third polymeric layer sufficient to not delaminate under a force of 10 pounds per square inch;
the third polymeric layer is a pre-formed crosslinked polyurethane film having a weight of between about 0.2 and 5 ounces per square yard;
the at least one fourth polymeric layer is about 0.05 to about 0.2 ounces per square yard of a thermoplastic polyurethane and an anti-stick agent; and
the textile is a plain weave fabric of intersecting warp and fill fibers of between about 600 and about 1200 denier and having a normalized weight from about 3.5 to about 5.5 ounces per square yard, wherein at least some of the fibers comprise nylon 12, nylon 715, nylon 6, or mixture thereof.

4. The laminate truck-grade tarp of claim 1, wherein
the first polymeric layer is between 2.5 to about 5 ounces per square yard and comprises a mixture of a vinyl chloride homopolymer, a copolymer containing vinyl halide-containing monomers and acid-containing monomers, and a polymerizable alkyl phthalate plasticizer, an antioxidant component, a UV protector, and a crosslinking agent;
the second polymeric layer is between about 0.2 and about 2 ounces per square yard of a water-cured substantially crosslinked polyurethane that was applied in uncured state in a formulation containing an organic solvent and having a viscosity of between about 4000 and about 25000 centipoise;
the third polymeric layer is a pre-formed crosslinked polyurethane film having a weight of between about 0.2 and about 2 ounces per square yard;
the at least one fourth polymeric layer is about 0.05 to about 0.2 ounces per square yard of a thermoplastic polyurethane and an organo-silicon anti-stick agent; and
the textile comprises intersecting warp and fill fibers, wherein at least some of the fibers comprise nylon, of between about 840 to about 1050 denier and having a normalized weight from about about 4.3 to about 4.8 ounces per square yard and a tensile (grab) strength of at least about 250×245 pounds.

5. The laminate truck-grade tarp of claim 1, wherein
the first polymeric layer is between about 3.2 to about 4.5 ounces per square yard and comprises a mixture of a vinyl chloride homopolymer, a copolymer containing vinyl halide-containing monomers and acrylic acid-containing monomers, a polymerizable alkyl phthalate plasticizer, an antioxidant component, and a UV protector, and a urea-formaldehyde resin crosslinking agent;
the second polymeric layer is between about 0.2 and about 2 ounces per square yard of a water-cured substantially crosslinked polyurethane that was applied in uncured state in a formulation containing an organic solvent and having a viscosity of between about 9000 and about 15000 centipoise;
the third polymeric layer is a pre-formed crosslinked polyether polyurethane film having a weight of between about 0.5 and about 1.5 ounces per square yard;
the at least one fourth polymeric layer comprises a thermoplastic polyurethane and an organo-silicon anti-stick agent, wherein each of the fourth polymeric layers is applied at about 0.05 to about 0.2 ounces per square yard; and
the textile comprises intersecting warp and fill fibers of between about 840 to about 1050 denier, at least some fibers consisting essentially of nylon 12, nylon 715, nylon 6, or blend thereof, and having a normalized weight from about 4.3 to about 4.8 ounces per square yard;
wherein the laminate truck-grade tarp has a normalized weight between about 10 and about 12 ounces per square yard.

6. The laminate truck-grade tarp of claim 1, wherein the normalized weight of the first polymeric layer is from about 4 to about 7 ounces per square yard.

7. The laminate truck-grade tarp of claim 1, wherein the first polymeric layer substantially fills the interstices of the textile and substantially blocks the second polymeric layer material from entering the textile interstices.

8. The laminate truck-grade tarp of claim 1, wherein the second polymeric layer, prior to curing, comprises an uncured water-curable thermoset polyurethane formulation of polyisocyanates and polyols admixed with thermoplastic polymers.

9. The laminate truck-grade tarp of claim 2, wherein
the first polymeric layer material comprises:
(A) between about 30% and about 42% of a crosslinkable vinyl halide copolymer;
(B) between about 0.2% and 3% of carbon black;
(C) between about 40% and about 66% of polymerizable phthalate-based plasticizer, azelaic acid-based plasticizer, or mixture thereof;
(D) between about 0.1% and 3% of an antioxidant;
the second polymeric layer material comprises:
(A) between about 3% and about 14% of a polyisocyanate comprising 4,4′-Diphenylmethane Diisocyanate, (2,2;2,4) Diphenylmethane Diisocyanate, and higher oligomers of 4,4′-Diphenylmethane Diisocyanate;
(B) between about 40% to about 95% of an isocyanate-curable polyol,
wherein the second polymeric layer was applied as an uncured formulation comprising a solvent, and the viscosity of the uncured formulation was between about 4000 and about 25000 centipoise;
the third polymeric layer is a pre-formed crosslinked polyurethane film having a weight of between about 0.2 and 5 ounces per square yard; and
the textile comprises fibers of below about 1200 denier and has a normalized weight from about 3.5 to about 5.5 ounces per square yard.

10. The laminate truck-grade tarp of claim 1, wherein
the first polymeric layer material comprises between about 3 and about 6 ounces per square yard of a vinyl-acrylic acid copolymer and/or a vinyl chloride-acrylic acid copolymer, a vinylchloride monomer and/or homopolymer, a polymerizable phthalate-based plasticizer, azelaic acid-based plasticizer, or mixture thereof, and carbon black;
the second polymeric layer comprises a water-cured polyurethane formulated from polyisocyantes and polyesters, polyethers, polycarbonates, polyamines, or mixtures thereof.
the third polymeric layer is a pre-formed film comprising crosslinked polyurethane and having a weight of between about 0.5 and 2 ounces per square yard;
a fourth polymeric layer is disposed on both the first and the second side of the laminate truck-grade tarp, each fourth polymeric layer comprising about 0.01 to about 0.3 ounces per square yard of a substantially uncrosslinked weldable polymeric material; and
the textile is a plain weave fabric of intersecting warp and fill fibers comprising nylon 12, nylon 715, nylon 6, or mixture thereof and being between about 700 to about 1400 denier, the textile having a normalized weight between about 2.5 to about 6.5 ounces per square yard;
wherein the laminate truck-grade tarp has a normalized weight between about 10 and about 12 ounces per square yard.

11. The laminate truck-grade tarp of claim 1, wherein at least one of the first and second sides has a matte finish.

12. A laminate truck-grade tarp having a first side and a second side and a plurality of laminated polymeric layers, comprising:
optionally an interior fourth polymeric layer disposed on the first side and comprising a thermoplastic weldable polymer;
a third polymeric layer contacting the optional fourth polymeric layer, if present, and also contacting a second polymeric layer, the third polymeric layer consisting of a pre-formed film comprising cross-linked polymer;
a second polymeric layer contacting the third polymeric layer and also contacting a textile, the second polymeric layer comprising a crosslinked adhesive which was cured after contacting with the third layer and the textile, wherein the second polymeric layer adheres both to the textile and to the third polymeric layer with force sufficient to not delaminate under a force of 8 pounds per square inch;
a textile comprising fibers and contacting the second polymeric layer and a first polymeric layer;
a first polymeric layer comprising a crosslinked polymeric blend comprising polyvinylchloride, carbon black, and an antioxidant; and
optionally an exterior fourth polymeric layer disposed on the second side and comprising a weldable thermoplastic polymer;
wherein the laminate truck-grade tarp has a normalized weight below about 15 ounces per square yard, a tensile (grab) strength of at least about 200×200 pounds per inch, and is suitable for use as a truck-grade tarp.

13. The laminate truck-grade tarp of claim 12, wherein:
the first polymeric layer weighs between about 2.5 and about 8 ounces per square yard;
the second polymeric layer weighs between about 0.2 and about 2 ounces per square yard;
the third polymeric layer weighs between about 0.2 and about 2 ounces per square yard;
wherein at least one of the interior fourth polymeric layer and exterior fourth polymeric layer is present, and the at least one fourth polymeric layer comprises about 0.01 to about 0.2 ounces per square yard of a substantially uncrosslinked polymeric material comprising a thermoplastic polyurethane; and
the textile comprises nylon and weighs between about 4.3 to about 4.8 ounces per square yard;
wherein no layers delaminate under a delaminating force of 8 pounds per square inch.

14. The laminate truck-grade tarp of claim 13, wherein:
the first polymeric layer weighs between about 2.5 to about 5 ounces per square yard;
the second polymeric layer weighs between about 0.2 and about 2 ounces per square yard;
the third polymeric layer weighs between about 0.2 and about 2 ounces per square yard, and the total weight of the second and third polymeric layers is about 1.3 to about 2.5 ounces per square yard;
the at least one fourth polymeric layer weighs about 0.01 to about 0.2 ounces per square yard and further comprises an anti-stick agent; and
the textile weighs between about 2.5 to about 6.5 ounces per square yard,
wherein no layers delaminate under a delaminating force of 10 pounds per square inch, wherein delamination under stress occurs at a boundary between the textile and the second polymeric layer before the laminated-grade tarp tears, and wherein the laminate truck-grade tarp has a normalized weight between about 10 and about 12 ounces per square yard.

15. A method of manufacturing the laminate truck-grade tarp of claim 1, comprising:
(A) providing a textile comprising nylon;
(B) spreading uncured first polymeric layer material on a first side of the scrim or textile;
(C) substantially curing this first polymeric layer material to form a laminate;
(D) spreading an uncured adhesive to the second side of the laminate to form a second polymeric layer thereon, said uncured adhesive comprising solvent;
(E) heating the laminate to drive off substantially all of the solvent;
(F) applying a curing agent to the adhesive;
(G) overlaying the adhesive layer containing the curing agent with a pre-fabricated crosslinked polyurethane film, by applying pressure to force the film onto the adhesive;
(H) allowing the adhesive to cure;
(I) applying a thermoplastic fourth polymeric layer to the first, the second, or to both sides of the laminate;
(J) applying increased temperatures and pressure to cure the fourth layer and to further bond the laminate and to form a matte surface on at least one side of the laminate.

16. The method of claim 15, wherein the laminate truck-grade tarp is the laminate truck-grade tarp of claim 2.

17. The method of claim 15, wherein the laminate truck-grade tarp is the laminate truck-grade tarp of claim 3.

18. The method of claim 15, wherein the laminate truck-grade tarp is the laminate truck-grade tarp of claim 4.

19. The method of claim 15, wherein the laminate truck-grade tarp is the laminate truck-grade tarp of claim 9.

20. The method of claim 15, wherein the laminate truck-grade tarp is the laminate truck-grade tarp of claim 10.
